(19) United States
(12) Patent Application Publication
(10) Pub. No.: US 2013/0211880 A1
(43) Pub. Date: Aug. 15, 2013

(54) CHAT CATEGORIZATION AND AGENT PERFORMANCE MODELING

(71) Applicant: 24/7 Customer, Inc., (US)

(72) Inventors: Pallipuram V. KANNAN, Los Gatos, CA (US); Ravi VIJAYARAGHAVAN, Bangalore (IN); Rajkumar DAN, Bangalore (IN); Harsh SINGHAL, Bangalore (IN); Manish GUPTA, Bangalore (IN)

(73) Assignee: 24/7 CUSTOMER, INC., Campbell, CA (US)

(21) Appl. No.: 13/843,226

(22) Filed: Mar. 15, 2013

Related U.S. Application Data
(62) Division of application No. 13/161,291, filed on Jun. 15, 2011.
(60) Provisional application No. 61/415,201, filed on Nov. 18, 2010.
(60) Provisional application No. 61/425,084, filed on Dec. 20, 2010.

(51) Int. Cl. G06Q 10/06

(52) U.S. Cl. CPC G06Q 10/06393
USPC 705/7.32; 705/7.39

(57) ABSTRACT

Chat categorization uses semi-supervised clustering to provide Voice of the Customer (VOC) analytics over unstructured data via an historical understanding of topic categories discussed to derive an automated methodology of topic categorization for new data; application of semi-supervised clustering (SSC) for VOC analytics; generation of seed data for SSC; and a voting algorithm for use in the absence of domain knowledge/manual tagged data. Customer service interactions are mined and quality of these interactions is measured by “Customer's Vote” which, in turn, is determined by the customer's experience during the interaction and the quality of customer issue resolution. Key features of the interaction that drive a positive experience and resolution are automatically learned via machine learning driven algorithms based on historical data. This, in turn, is used to coach/teach the system/service representative on future interactions.

### CROSS REFERENCE TO RELATED APPLICATIONS

This application claims priority to U.S. patent application Ser. No. 13/161,291, filed Jun. 15, 2011 (attorney docket no. 247C0024), which claims priority to U.S. provisional patent application Ser. No. 61/415,201, filed Nov. 18, 2010 (attorney docket no. 247C0019) and U.S. provisional patent application Ser. No. 61/425,084, filed Dec. 20, 2010 (attorney docket no. 247C0020), each of which is incorporated herein in its entirety by this reference thereto.

### BACKGROUND OF THE INVENTION

1. Technical Field

The invention relates to text mining driven voice of the customer analysis. More particularly, the invention relates to a semi supervised clustering approach for chat categorization. The invention also relates to customer service monitoring. More particularly, the invention also relates to customer service performance measurement and coaching and agent performance modeling.

2. Description of the Background Art

Chat Categorization

In the present competitive scenario, the customer is considered as an asset for any kind of business. Every company not only wants to retain its existing customers, but also wants to acquire new customers. To predict the customer's behavior and satisfaction, Voice of the Customer (VOC) analytics over unstructured data sources such as chat transcripts, emails, surveys, etc. have become a necessity for many business units. VOC analysis also identifies features related to customer satisfaction using text mining and data mining techniques.

Chat categorization is one of the crucial tasks in VOC analysis which assigns the pre-defined business class to every chat transcripts based on context of chats. Chat categorization provides insight into customer needs by grouping the chats. Effective chat categorization helps to formulate policies for customer retention and target marketing in advance.

### DESCRIPTION OF EXISTING METHODOLOGY

In the past, many supervised (document classification) and unsupervised (document clustering) methods have been proposed for text categorization, but none of them are found suitable for chat categorization due to the paucity of labeled data and irrelevant cluster formation. The following discussion describes existing methods along with their limitation for text/chat categorization.

Existing Unsupervised Methods

The unsupervised methods do not require predefined classes and labeled data, unlike classification that assigns instances to predefined classes based on labeled data. Clustering (Gan G., Chaoqun M., Wu J., 2007. Data Clustering: Theory, Algorithms, and Applications, SIAM, Philadelphia; Jain A. K., Murty M. N., Flynn P. J., 1999. Data clustering: a review, ACM Computing Surveys, 31(3), 264-323; McQueen J., 1967. Some methods for classification and analysis of multivariate observations, Proceedings of Symposium on Mathematics, Statistics & Probability, Berkeley, 1, 281-298) is an important unsupervised technique. Clustering is the process of organizing data objects into groups, such that similarity within the same cluster is maximized and similarity among different clusters is minimized. The methods of clustering are broadly divided into two categories viz. hierarchical based clustering and partition based clustering.

Hierarchical (Johnson S. C., 1967. Hierarchical clustering schemes. Psychometrika, 32(3), 241-254) based clustering algorithms groups the data objects by creating a cluster tree referred to as a dendrogram. Groups are then formed by either an agglomerative approach or a divisive approach. The agglomerative approach starts by considering each data instance as a separate group. Groups, which are close to each other, are then gradually merged until finally all objects are in a single group. The divisive approach begins with a single group containing all data objects. The single group is then split into two groups, which are further split, and so on until all data objects are in groups of their own. The drawback of Hierarchical clustering is that once a step of merge or split is done it can never be undone.

One of the most popular partition based clustering is K-means (McQueen, supra). K-means randomly selects fixed number, e.g. K, of initial partitions and then uses iterative relocation technique that attempts to improve the partitioning by moving objects from one group to another. The major drawback of K-means is that the number of clusters is to be known a priori.

Although, clustering methods are used for text categorization and document clustering, these methods do not perform well for chat categorization problems due to the following limitations.

Limitations of Unsupervised Methods for Chat Categorization

The unsupervised methods provide only natural clusters irrespective of whether they belong to a meaning class or not. Chat categorization is the problem not to obtain natural clusters, but to categorize chats into meaningful classes. The existing unsupervised methods also do not incorporate the valuable domain/expert knowledge into the learning process.

Existing Supervised Methods

The supervised methods predict the classes of the test data based on the model derived from training data, which is a set of instances with known classes. Several unsupervised methods along with their limitations have been briefly described below.

One of the earliest methods of classification is k-Nearest Neighbors (KNN) (Cover T. M., Hart P. E., 1967. Nearest Neighbor Pattern Classification. IEEE Transactions On Information Theory, IT-13, 1, 21-27; Aha et al. 1991; Duda R. O., Hart P. E., Stork D. G., 2000. Pattern classification, Second Edition. John Wiley & Sons, Inc., New York). KNN classifies a test instance by finding k training instances that are closest to the test instance. A test instance is assigned to the class which is the most common among its k nearest neighbors. The two major limitations of KNN are that it requires enormous computational time for finding k nearest neighbors and it highly depends on the metric that is used for obtaining nearest neighbors.

Another popular classification method is Decision Trees (DT) which was introduced by Breiman et al, (Breiman L., Friedman J. H., et al., 1984. Classification and Regression Trees. Chapman and Hall, New York) and Quinlan (Quinlan J. R., 1986. Induction of decision trees, Machine Learning, 81-106) in the early 1980s. Decision trees are tree-shaped structures which represent a set of decisions. DT partitions the input space based on a node splitting criteria. Each leaf node of DT represents a class. Information Gain, Gain Ratio and Gini Index are widely used node splitting measures. The classification accuracy using DT depends on split measure which selects the best feature at each node. Many decision tree algorithms based on different split measure have been introduced in the past, such as Classification and Regression Trees (CART) (Breiman et al, supra), Interactive Dichotomizer 3 (ID3) (Quinlan, supra), C4.5 (Quinlan J R. 1993. C4.5: Programs for Machine Learning, Morgan Kaufmann Publishers, San Mateo, Calif.), Sequential Learning in Quest (SLIQ) (Mehta M., Agrawal R., Riassnen J., 1996. SLIQ: A fast scalable classifier for data mining, Extending Database Technology, 18-32). The main problem of Decision Trees as a classification method is that they are very sensitive to overtraining. Another problem of Decision Trees is that they require pruning algorithms for discarding the unnecessary nodes.

One of the most effective classifiers, Naive Bayes Classifier (NBC) has been described by Langley et al. (Langley, P., Iba, W., Thompson, K. 1992. An analysis of Bayesian classifiers. In Proc. of 10th National Conference on Artificial Intelligence, 223-228) and Friedman et al. (Friedman N., Geiger D., Goldszmidt M., 1997. Bayesian network classifiers, Machine Learning, 29, 131-163). NBC is based on Bayes' theorem according to which test instance is assigned to a particular class with highest posterior probability. NBC is simple probabilistic classifier with the assumption of class conditional independence. Although, assumption is violated for many real world problems but comparative studies (Domingos, P., Pazzani, M., 1997. On the optimality of the simple Bayesian classifier under zero-one loss. Machine Learning, 29, 103-130; Zhang H., 2005. Exploring conditions for the optimality of naive Bayes. International Journal of Pattern Recognition and Artificial Intelligence, 19(2) 183-198) show that NBC outperforms three major classification approaches, including the popular C4.5 Decision Tree algorithm. NBC also does not have the limitations of DT-like pruning and overtraining. NBC requires only a small amount of training data to estimate the parameters necessary for classification.

Vapnik (Vapnik V., 1995. The Nature of Statistical Learning Theory, Springer, NY) introduced another popular classification method referred to as Support Vector Machines (SVM). SVM performs classification by constructing optimal hyperplanes in the feature vector space to maximize the margin between a set of objects of different classes. A kernel function is used to construct nonlinear decision boundary. The major limitation of SVM is that the accuracy of SVM largely depends upon a suitable kernel function, but selecting a suitable kernel function is very subjective and problem specific.

Özyurt et al., (2010) presents an automatic determination of chat conversations' topic in Turkish text based chat mediums using Naive Bayes, k-Nearest Neighbor and Support Vector Machine. The paper considers informal/social chat transcript data instead of customer oriented business chat which are being used for building VOC solution. The following section highlights the major limitation for chat categorization.

Limitation of Supervised Methods for Chat Categorization

In the past, many supervised methods viz. Naive Bayes, k-Nearest Neighbor, and Support Vector Machine have been applied to many text categorization problems. But the existing supervised methods require a good amount of training data which is hardly available in the case of chat categorization. The accuracy of chat categorization directly proportional to the amount of training data, i.e. less training data, means less classification accuracy.

Existing Semi-Supervised Clustering

There is always a need to develop an efficient Semi-Supervised Clustering (SSC) algorithm for chat categorization because neither supervised nor unsupervised learning methods in a standalone manner provide satisfactory results in many real world problems. Semi-Supervised Clustering (SSC) (Bar-Hillel A, Hertz T, et al., 2005. Learning a Mahalanobis metric from equivalence constraints. Journal of Machine Learning Research, 6, 937-965; Chapelle O., Schölkopf B., Zien A., 2006. Semi-supervised learning, MIT Press Cambridge) is becoming popular for solving many practical problems.

Semi-supervised clustering uses a small amount of labeled objects, where information about the groups is available, to improve unsupervised clustering algorithms. Existing algorithms for semi-supervised clustering can be broadly categorized into constraint-based and distance-based semi-supervised clustering methods. Constraint-based methods (Wagstaff K., Rogers S. 2001. Constrained k-means clustering with background knowledge, In Proc of 18th International Conf. on Machine Learning 577-584; Chapelle et al., supra; Basu S., Banerjee A., Mooney R. J., 2002. Semi-supervised clustering by seeding, Proc of 19th International Conference on Machine Learning, 19-26; Basu S., Banerjee A., Mooney R. J., 2004 Active semi-supervision for pairwise constrained clustering, Proc. of the 2004 SIAM International Conference on Data Mining (SDM-04); Basu S., Bilenko M., Mooney R. J., 2004. A probabilistic framework for semi supervised clustering. Proc of 10th ACM SIGKDD International Conference on Knowledge Discovery and Data Mining (KDD-2004), 59-68) are generally based on pair-wise constraints, i.e. pairs of objects labeled as belonging to same or different clusters, to facilitate the algorithm towards a more appropriate partitioning of data. In this category, the objective function for evaluating clustering is modified such that the method satisfies constraints during the clustering process. In distance-based approaches (Bar-Hillel et al., supra; Bilenko M., Basu S., Mooney R., 2004. Integrating constraints and metric learning in semi-supervised clustering, Proc. of International Conference on Machine Learning (ICML-2004), 81-88; Xing E. P., Ng A. Y., et al., 2003. Distance metric learning, with application to clustering with side-information, Advances in Neural Information Processing Systems, 15, 505-512), an existing clustering algorithm uses a particular distance measure. Xiang et al. (Xiang S., Nie F., Zhang C., 2008. Learning a Mahalanobis distance metric for data clustering and classification. Pattern Recognition, 41(12), 3600-3612) consider a general problem of learning from pair wise constraints and formulate a constrained optimization problem to learn a Mahalanobis distance metric, such that distances of point pairs in must-links are as small as possible and those of point pairs in cannot-links are as large as possible.

Limitation of Existing Semi-Supervised Clustering for Chat Categorization

Existing semi supervised clustering algorithms fail to address the following crucial problems in clustering process:

Firstly, pair-wise constraints based semi-supervised clustering approach requires two kinds of constraints viz. must-link and cannot-link. These pair-wise constraints could be misleading in constraint-based semi-supervised clustering methods. If the constraints are generated from the class labels, then the must-link constraints could be incorrect when a particular class has more than one cluster in it. Similarly, cannot-link constraints are not sufficient conditions because two data points with incorrect clusters can still satisfy the cannot-link constraints.

Secondly, same weights are assigned to all the features in many clustering algorithms irrespective of the fact that all features do not have equal importance or weights in most of the real world problems. In distance-based semi-supervised clustering methods, this problem has been tackled by giving subjective weights for each feature.

It would be advantageous to provide a technique that overcomes the above mentioned limitations of existing methods for chat categorization

Agent Performance

Agent performance is a major driver of key business metrics, such as resolution and customer satisfaction. However, current quality assurance is a manual process where only a very small fraction of the transactions are used to score customer performance.

It would be advantageous to provide a comprehensive framework for managing agent performance metrics objectively in a data driven way. It would be further advantageous to provide a technique for measuring and managing agent performance using standard metrics and unstructured (textual) data from transcripts.

### SUMMARY OF THE INVENTION

Chat Categorization

An embodiment of the invention overcomes the above mentioned limitations of existing methods for chat categorization by providing a novel semi-supervised clustering approach. Embodiments of the invention provide four major contributions for Voice of the Customer (VOC) analytics over the unstructured data:
Use of historical understanding of topic categories discussed to derive an automated methodology of topic categorization for new data;
Application of Semi-supervised Clustering (SSC) for VOC analytics, e.g. categorization of textual customer interactions including social media, emails, chats, etc.;
A novel algorithm to generate seed data for the SSC algorithm; and
Introduction of a voting algorithm in absence of domain knowledge/manual tagged data.

Agent Performance

In an embodiment, customer service interactions through voice, email, chat, and self service are mined. The quality of these service interactions is often measured by the “Customer's Vote” (for example—Customer surveys on CSAT, FCR, etc.). The customer vote is in turn determined by the customer's experience during the interaction and the quality of customer issue resolution.

An embodiment of the invention provides an approach that automatically learns, via machine learning driven algorithms, the key features of the interaction that drive a positive experience and resolution, based on historical data, e.g. prior interactions. This, in turn, is used to coach/teach the system/service representative on future interactions. An instance of this embodiment as applicable to chat as a customer service channel is provided below.

An embodiment of the invention also provides a single data model that integrates chat metadata, e.g. handle time, average response time, agent disposition, etc.; chat transcripts, customer surveys, both online and offline; weblogs/web analytics data; and CRM data. The chat transcript itself is extensively text mined.

An embodiment produces a net experience score, i.e. a text mined score that measures the customer sentiment.

An embodiment also produces a differential net experience score, i.e. change in the net experience score of the customer from the beginning to end of the conversation. This is a novel approach to measuring the ability of the agent to change a customer's mood/sentiment over the course of the agent's conversation with the customer.

### BRIEF DESCRIPTION OF THE DRAWINGS

FIG. 1 is a block schematic diagram showing the architecture of a system for chat categorization using semi-supervised clustering according to the invention;

FIG. 2 is a flow diagram showing a step-by-step process of seed data generation according to the invention;

FIG. 3 is a graph showing that the herein disclosed SSC algorithm produces overall accuracy far better than that produced using existing algorithms;

FIG. 4 is a graph showing an example of level I group-wise accuracy by different methods for a retail company;

FIG. 5 is a graph showing an example of level II group-wise accuracy by different methods for a retail company;

FIG. 6 is a graph showing level II group-wise accuracy for a banking company;

FIG. 7 is a block schematic diagram showing agent performance according to the invention;

FIG. 8 is a block schematic diagram showing agent performance impact, especially with regard to operations (tracking issue analytics) according to the invention;

FIG. 9 is a block schematic diagram showing agent performance impact with regard to operations (Aggregate Deep Dive) according to the invention;

FIG. 10 is a block schematic diagram showing agent performance Impact with regard to operations (Targeted Deep Dive) according to the invention;

FIG. 11 is a block schematic diagram showing agent performance impact with regard to operation QA (Targeted Monitoring) according to the invention;

FIG. 12 is a block schematic diagram showing text mining architecture according to the invention;

FIG. 13 is a block schematic diagram showing modeling with regard to individual modeling components and types according to the invention;

FIG. 14 is a block schematic diagram showing calls analytics solution by triggering according to the invention;

FIG. 15 is a table showing a logistic regression model according to the invention;

FIG. 16 is a graph showing structured/unstructured data modeling with regard to important variables (FCR) according to the invention;

FIG. 17 provides four graphs which show structured data modeling results with regard to variable distribution according to the invention;

FIG. 18 is a table showing a logistic regression model;

FIG. 19 is a graphic representation of a confusion matrix according to the invention;

FIG. 20 provides a graph and a table showing an FCR decile chart according to the invention;

FIG. 21 shows an error chart according to the invention;

FIG. 22 is a graph showing an accuracy report for the resolution model according to the invention;

FIG. 23 is a graph showing misclassified records analysis on a validation set according to the invention;

FIG. 24 is a block schematic diagram showing an agent softskill model with regard to a preparation phase according to the invention;

FIG. 24a is an example screenshot showing [symbol] according to the invention;

FIG. 25 is a pair of graphs that show performance of structured and unstructured data model for CSAT according to the invention;

FIG. 26 is a set of graphs and tables that show performance measured on deciles of calculated scores according to the invention;

FIG. 27 is a table that shows estimated coefficients according to the invention;

FIG. 28 is a table that shows a logistic regression model according to the invention;

FIG. 29 is a flow diagram showing selection of discriminating features from chat interactions according to the invention;

FIG. 30 is a flow diagram showing feature selection from a feature matrix according to the invention; and

FIG. 31 is a flow diagram that shows identification of satisfaction and dissatisfaction propensity in chat interactions by use of discriminatory features according to the invention.

### DETAILED DESCRIPTION OF THE INVENTION

Chat Categorization

Voice of the Customer (VOC) Analysis over unstructured data sources, such as chat transcripts, emails, surveys, etc. are becoming popular for wide variety of business application viz. customer relationship management, prediction of customer behavior, etc. Chat categorization is considered one of the essential tasks to generate VOC.

In the past, many supervised and unsupervised methods have been proposed for text categorization, but none of them are suitable for chat categorization due to the paucity of labeled data and irrelevant cluster formation. An embodiment of the invention provides a novel semi-supervised clustering approach to chat categorization that not only considers the valuable domain knowledge, but also categorize chats into meaningful business classes. The disclosed technique also addresses a fundamental problem for text categorization which arises due to the skewed class distribution. The effectiveness of the disclosed technique has been illustrated on a real world chat transcripts dataset. The comparative evaluation also provides evidence that the disclosed technique for chat categorization outperforms the existing unsupervised and pair-wise semi-supervised clustering methods.

Application of Semi-Supervised Clustering for VOC analytics e.g. Chat Categorization

Chat categorization is one of the crucial tasks in VOC analysis, which assigns the pre-defined business class to every chat transcript based on context of chats. Chat categorization provides insight into customer needs by grouping the chats. In the past, many supervised and unsupervised methods have been proposed for text categorization, but none of them are found suitable for chat categorization due to the paucity of labeled data and irrelevant cluster formation.

An embodiment of the invention provides a novel, semi-supervised clustering approach which not only considers the valuable domain knowledge, but also categorize chats into meaningful business classes.

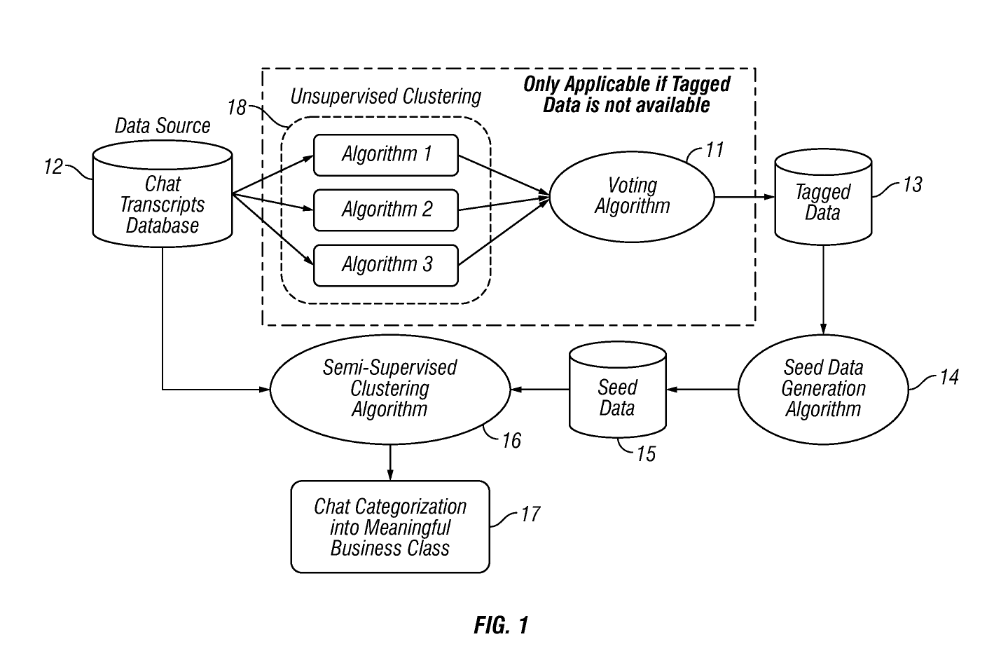

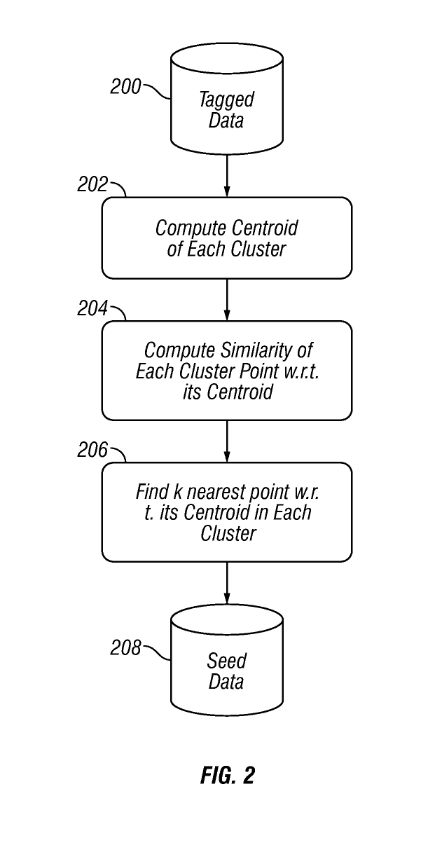

FIG. 1 is a block schematic diagram showing the architecture of a system for chat categorization using semi-supervised clustering according to the invention. According to architecture, a voting algorithm 11, having as an input the results of the applications of various unsupervised clustering algorithms 18, is applicable in the absence of tagged data. Tagged data can also be formed by domain knowledge. The seed data 15 which is required for the semi-supervised clustering algorithm 16 can be generated from tagged data 13 by applying a seed data generation algorithm 14. A unique k-nearest neighbor (k-NN) method based seed data generation algorithm is also disclosed to handle the skewed class distribution in the tagged data. The seed data generation algorithm is discussed in the subsequent section. The semi-supervised clustering algorithm (see Table 1 below) categorizes the chat transcripts from a chat transcript database 12 in meaningful business classes 17 by initializing and guiding clustering based on seed data.

TABLE 1
Step-By-Step Process Of An Exemplary
Semi-Supervised Clustering Algorithm

Input: Chat Data, Tagged Data, Size of nhd (k), No. of Clusters
Output: Cluster Assignment to Chat Data i.e. Chat Categorization
Procedure:
Handling the of Null Records i.e. does not contain any feature vectors
Generate Seed Data

Compute Centroid Matrix, based on Tagged Data
Find k Data Points from each cluster as Seed which are nearest to
its Centroid
If the number of data points in a Cluster is less than k then select
all data points of the cluster as seed data

Compute Centroid Matrix based on Seed Data
Repeat until convergence

For each data point x of Chat Data

If data point x belongs to seed data

Assign same cluster index to x as given in seed data

Else

Compute similarity of x with each cluster centroid
Assigned x to nearest cluster

End

End
Re-compute Centroid Matrix based on new cluster assignment
Compute Mean Square Error
If Error < Specified Error
Break;
Else
Repeat the Process
End

Return Cluster Assignment Matrix

A Novel Algorithm to Generate Seed Data for SSC Algorithm

A fundamental problem for chat categorization arises due to the skewed class distribution. It has been noted that the class distribution is much skewed. Some of the classes contain almost 50% of records, whereas others are almost 0%. Therefore, clustering results are not satisfactory due to asymmetric distribution among classes.

The existing pair-wise constrained based semi-supervised clustering fails to address the skewed class distribution problem. The seeded constrained semi-supervised clustering can be useful for such scenarios, but the choice of accurate and skew free seed data is difficult to obtain. There is always a need of accurate seed data for semi-supervised clustering. An embodiment of the invention provides a unique seed data generation algorithm to address the fundamental problem for text categorization which arises due to the skewed class distribution.

The exemplary approach also addresses the problem by generating seed data using k-nearest neighbor (k-NN) method which samples out tagged data uniformly and thus limit the effect of majority class for learning process.

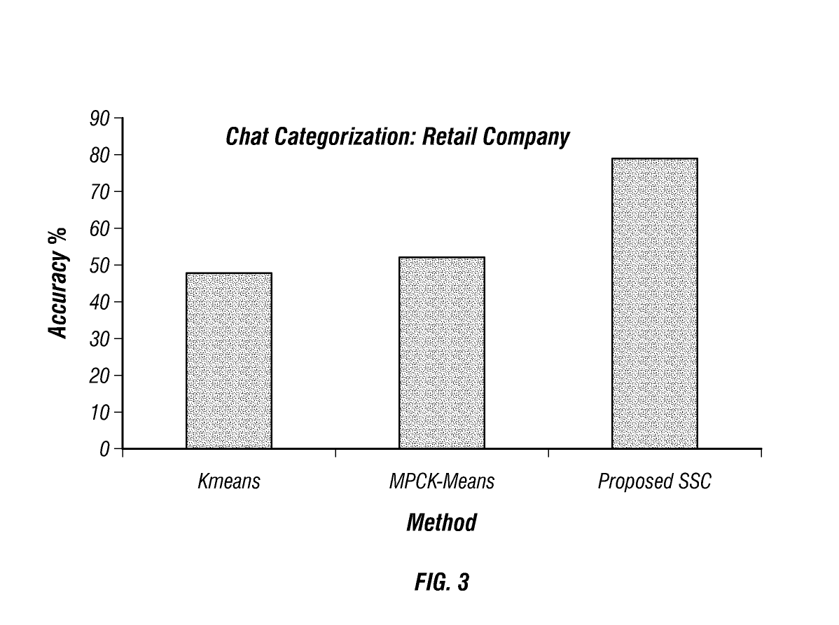

FIG. 3 is a graph showing that the herein disclosed SSC algorithm produces overall accuracy far better than that produced using existing algorithms. The skewed tagged data is taken as an input to seed data generation algorithm (200). It is assumed that tagged data contains at least one data point of each cluster (202). The seed data generation process selects those data objects which are closest to each cluster's centroid (204). We select uniformly equal amount of data points as seed data points from each cluster (206), thus producing seed data (208). Therefore, we are able to handle skewed class distributions.

Introduction of Voting Algorithm in Absence of Domain Knowledge/Manual Tagged Data

It has been observed that user domain knowledge/tagged data is not available for many real world datasets. In such cases, tagged data is generated by manual tagging by reading the chats. If we would like to scale up a chat categorization process for any kind of customer data then the manual tagging process can not be feasible.

To automate the process fully and discard the need of manual tagging process, we have developed a unique voting algorithm for generating the tagged data as required for seed data generation. Table 2 describes the step by step process of proposed voting algorithm for generating tagged data.

TABLE 2
Step by step process of proposed voting
algorithm for generating tagged data

Input: Chat Data, no. of clusters
Output: Tagged Data
Procedure:
Handling the of Null Records i.e. does not contain any feature vectors
Applying Different Unsupervised Methods

Applying Algorithm 1−> Cluster_Assignment_1, Centroid Maxtrix
Applying Algorithm 2−> Cluster_Assignment_2
Applying Algorithm 3−> Cluster_Assignment_3

Reconstruction of Cluster_Assignment_2 w. r. to Cluster_Assignment_1

Create Confusion Matrix
Obtain the number of points belong to each class
Generate Cluster Vs Class Matrix
Substitution of class index in place of cluster Ixdex
Cluster_Assignment_2

Reconstruction of Cluster_Assignment_3 w. r. to Cluster_Assignment_1
similar to earlier one
Identification of Universally Match Records
Tagged Data Generation based on Universally Match Records
Testing Assumption that tagged data contains at least one record for each
class

If test fails then incorporation of cluster centers in Tagged as records
for missing class

Return Tagged Data

According to the algorithm, it considers the cluster assignment matrixes generated by various unsupervised clustering methods and selects only those data objects as tagged data which are assigned by each of the algorithms in the same cluster. The results show that the proposed algorithm performs remarkably well for generating tagged data in chat categorization process. The next section provides the comparative results of the proposed algorithm with the existing unsupervised clustering and semi-supervised clustering methods on two real world dataset.

Comparative Results

The effectiveness of the proposed approach has been illustrated on two real world chat transcripts datasets. The comparative evaluation also provides evidence that the proposed approach for chat categorization outperforms the existing unsupervised and pair-wise semi-supervised clustering methods.

Table 3 below shows the comparative results of chat categorization for one of the retail companies. It is observed that the existing methods, such as Kmeans and MPCK-Means, fail to categorize the chats which belong to minority classes, whereas the proposed semi-supervised clustering approach is able to correctly categorize those classes.

TABLE 3
Retail Company Comparative Results

| | | | Predicted | | |
|---|---|---|---|---|---|
| Group | | | | MPCK- | Proposed |
| Label | Class Label | Actual | Kmeans | Means | SSC |
| Price | Doubtful Of Qualifying | 9 | 0 | 0 | 8 |
| | Not Enough Credit Limit | 87 | 0 | 56 | 52 |
| | Payment Options | 69 | 0 | 0 | 57 |
| | Too Expensive | 16 | 0 | 0 | 15 |
| Process | Fingerhut Account Issues | 58 | 0 | 0 | 41 |
| | Just Researching | 947 | 617 | 487 | 756 |
| | Need To Consult Others | 10 | 0 | 0 | 8 |
| | Postpone Purchase | 132 | 132 | 94 | 94 |
| | Prefer To Call | 59 | 0 | 50 | 51 |
| | Previous Bad Experience | 13 | 13 | 0 | 5 |
| | Shipping/Delivery Options | 129 | 0 | 59 | 78 |
| | Technical Issues | 79 | 21 | 43 | 78 |
| Product | Did Not Get Product Info/Spec | 142 | 102 | 139 | 142 |
| | Product Out Of Stock | 10 | 0 | 0 | 5 |
| | Refund Policy | 2 | 0 | 0 | 2 |
| | Return Policy | 6 | 0 | 0 | 5 |
| | Warranty Policy | 19 | 0 | 0 | 13 |
| Promotions | Invalid/No Promotion Code | 35 | 0 | 34 | 34 |
| | No Discount/Sales/Clearance On | 16 | 0 | 0 | 13 |
| | Products | | | | |
| | Want Free Gifts | 7 | 0 | 0 | 7 |
| | TOTAL | 1845 | 885 | 962 | 1464 |

FIG. 3 is a graph showing that the herein disclosed SSC algorithm produces overall accuracy far better than that produced using existing algorithms.

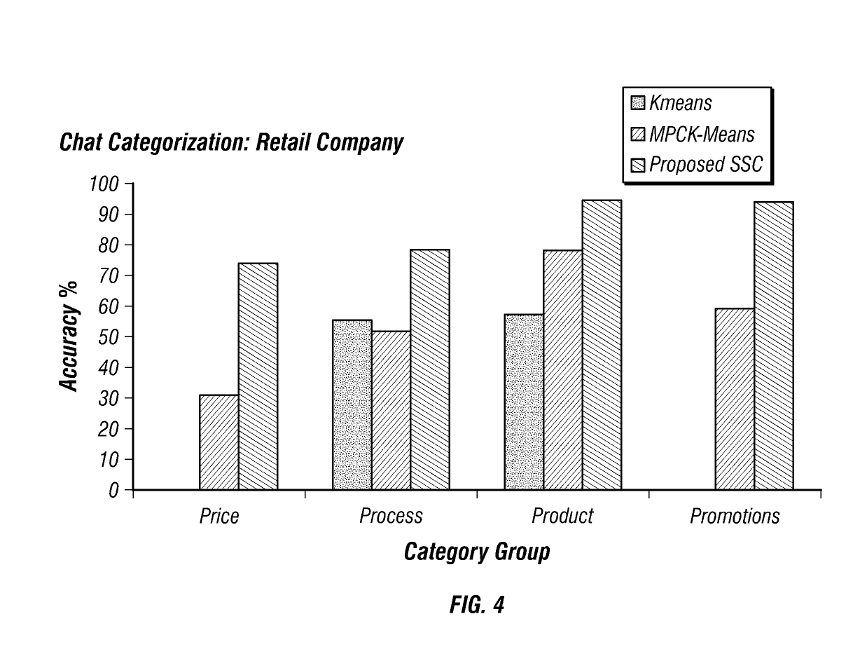

Table 4 below shows the accuracies of Level I group for each comparative methods. FIG. 4 is a graph showing an example of level I group-wise accuracy by different methods for a retail company. It can been from FIG. 4 that the proposed SSC algorithm not only does remarkably well for each group, but also produces more than 90% accuracy for product and promotion group.

TABLE 4
Retail Company Level I Group-wise Comparative Results

| | | MPCK- | Proposed |
|---|---|---|---|
| Group | Kmeans | Means | SSC |
| Price | 0.00 | 30.94 | 72.93 |
| Process | 54.87 | 51.37 | 77.86 |
| Product | 56.98 | 77.65 | 93.30 |
| Promotions | 0.00 | 58.62 | 93.10 |

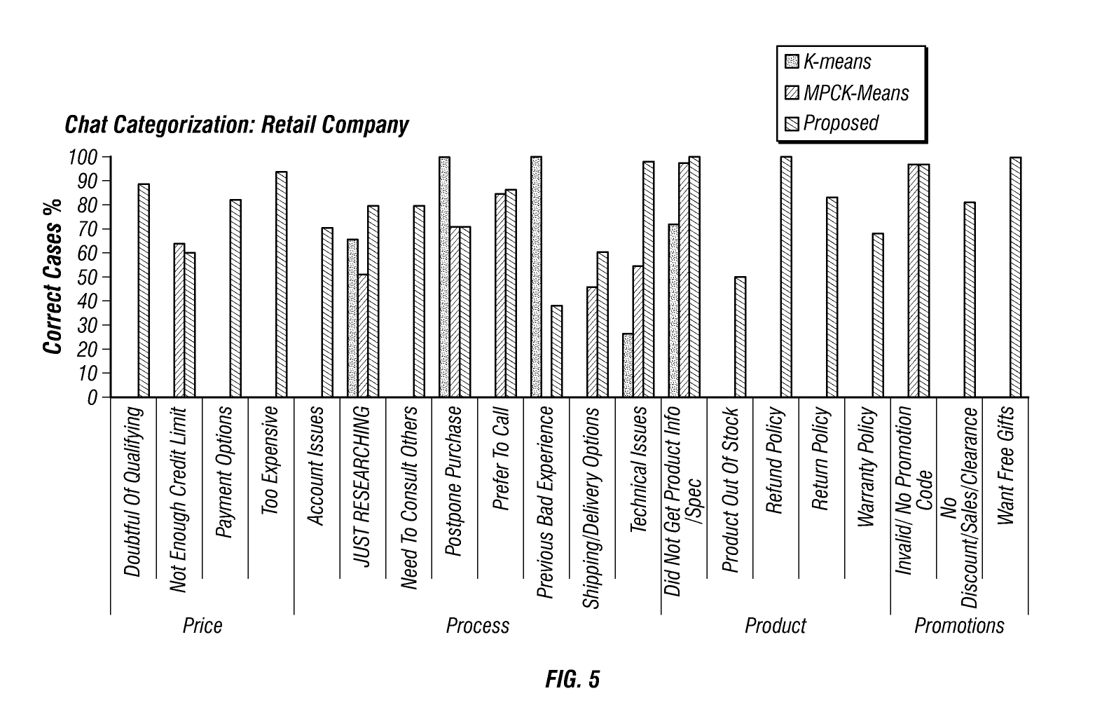

FIG. 5 is a graph showing an example of level II group-wise accuracy by different methods for a retail company. The similar results can be seen in FIG. 5 for Level II chat categorization for the same retail company.

To ascertain about the efficacy of the proposed approach on other real world dataset, It has been applied for chat categorization of one of the banking companies.

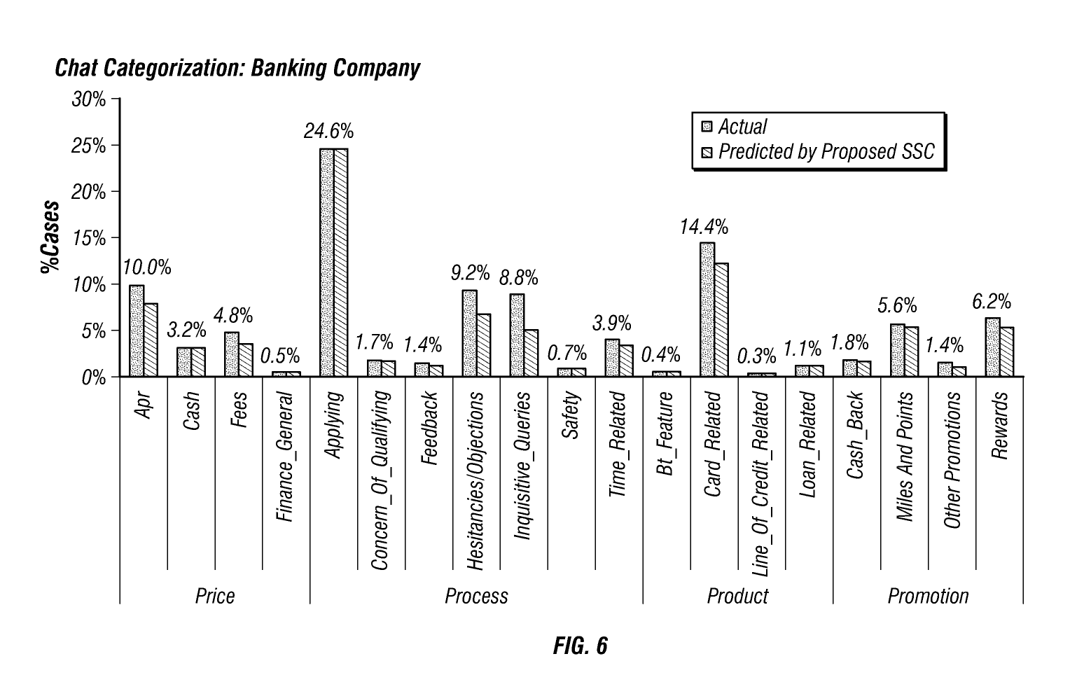

FIG. 6 is a graph showing level II group-wise accuracy for a banking company. FIG. 6 shows the results of Level II chat category by proposed SSC versus actual one. It can be observed that the proposed SSC algorithm produces almost similar trends as the actual one.

Conclusion—Chat Categorization

Preferred embodiments of the invention provide a novel semi-supervised clustering approach which not only considers the valuable domain knowledge, but also categorize chats into meaningful business classes. The disclosed seed data generation approach also addresses a fundamental problem for text categorization which arises due to the skewed class distribution. The voting algorithm can also fill the gap whenever there is no tagged data available.

Agent Performance Modeling

Definitions

CSAT—Customer Satisfaction

FCR—First Call Resolution

Discussion

Customer service interactions through voice, email, chat, and self service can be mined. The quality of these service interactions is often measured by the “Customer's Vote” (for example—Customer surveys on CSAT, FCR, etc.). The customer vote is in turn determined by the customer's experience during the interaction and the quality of customer issue resolution.

An embodiment of the invention provides an approach that automatically learns, via machine learning driven algorithms, the key features of the interaction that drive a positive experience and resolution, based on historical data, e.g. prior interactions. This, in turn, is used to coach/teach the system/service representative on future interactions. An instance of this embodiment as applicable to chat as a customer service channel is provided below.

An embodiment of the invention also provides a single data model that integrates chat metadata, e.g. handle time, average response time, agent disposition, etc.; chat transcripts, customer surveys, both online and offline; weblogs/web analytics data; and CRM data. The chat transcript itself is extensively text mined for:
Issue type (using a customer query categorization model)
Empathy
Helpfulness
Professionalism
Clarity
Understanding
Attentiveness
Knowledge
Resolution
Influencing
Customer effort during the conversation

An embodiment produces a net experience score, i.e. a text mined score that measures the customer sentiment.

An embodiment also produces a differential net experience score, i.e. change in the net experience score of the customer from the beginning to end of the conversation. This is a novel approach to measuring the ability of the agent to change a customer's mood/sentiment over the course of the agent's conversation with the customer.

Structured attributes are also used such as:
Handle Time of chat
Issue Type (if coming from Agent disposition or Customer pre-chat form)
Average response time of agents (metadata—extracted from chat text)
Standard Deviation of response time
Agent lines
Customer lines
Agent first line after chat start

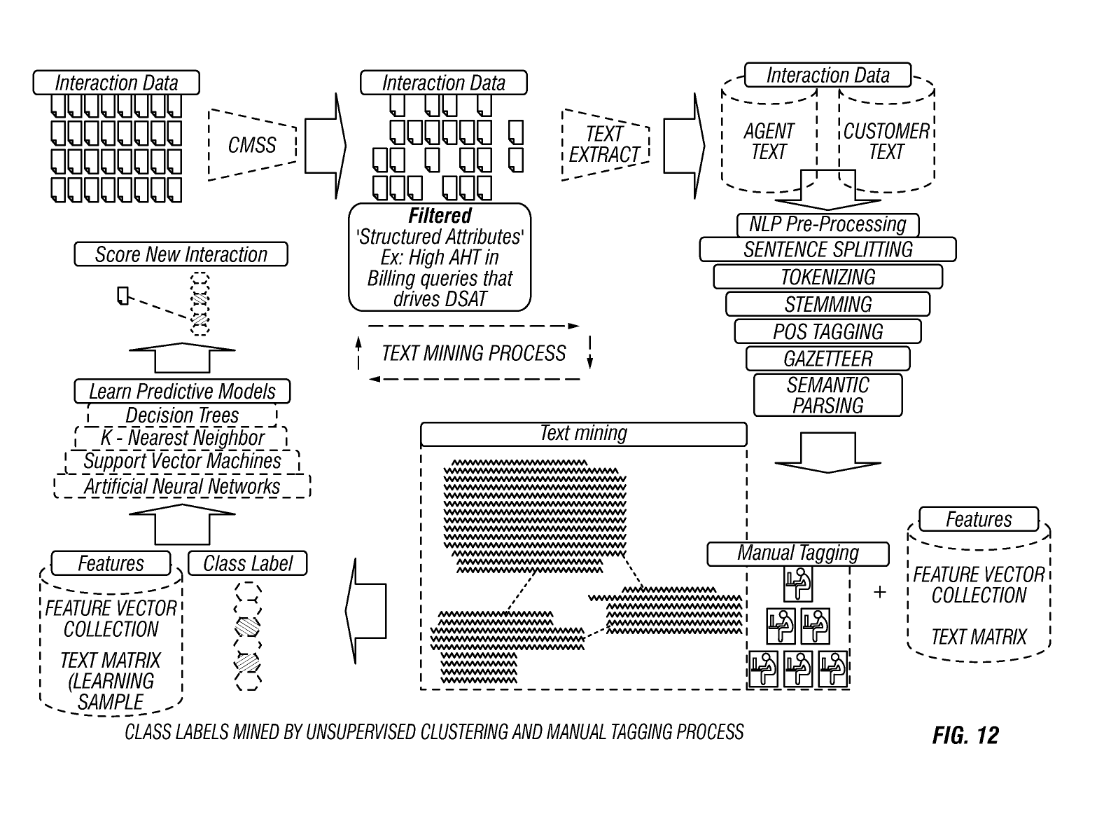

Each of these attributes has a model associated with it. This model is derived using data mining, text mining, Natural Language Processing, and Machine learning (see FIGS. 12-14 and 24).

There are two major machine learning components in the presently preferred embodiment of the invention. The model for each of the attributes identified in the chat transcript (see above) is built based, not on subjective measures, but actually based on customer votes. For example, a text mining model to understand what are features of a conversation that best represent an issue being resolved for a customer is learned by the model from historical chat transcripts, where the customer actually voted that they felt that the quality of resolution was high. Similarly, the features of the conversation that best represent poor resolution are also learned from chats that were voted poor on resolution by the customer.

The relative importance/weights of each of the above attributes, both from the chat transcript and from structured attributes, in influencing/driving CSAT, FCR, and other customer experience measures is derived using statistical methods, such as logistic regression and structural equation modeling. The model can identify, for example, issues, agents, products, processes, price, and customer segments that drive poor customer experience and resolution. One use of the model is to score agents on all the attributes listed above. In addition, the agents are scored on derived scores which are functions of these attributes. These derived scores can be used for agent quartiling, i.e. dividing the agents into four quartiles based on performance, and scoring. These scores proxy agent performance parameters, such as resolution effectiveness, interaction effectiveness, and effectiveness in reducing customer effort. The model is used to break down the drivers and their relative importance in contribution to key customer measures such as Customer Satisfaction, Customer Experience, and Issue Resolution. Thus, the model identifies the drivers for improvement with measurable impact thereby help user to prioritize action.

Current quality assurance is a manual process where only a very small fraction of the transactions are used to score customer performance. Text/Data Mining enables the ability to score 100% of the transactions.

Integration of Quality Assurance (QA), Customer Survey, and Structured and Unstructured Data Mining Models

The QA input, though only a small sample fraction, is used by the machine learning model to learn features that drive a certain quality attribute. The QA input itself can be weighted based on historical quality/ability of the QA analyst. QA integration provides richer data and more contextual feedback to the model scoring process.

A key application of the model is to help the QA process as well. Typically, the QAs randomly sample 1-5% of the chats, read these chats, and make comments on various skills of the agent such as knowledge, problem resolution, clarity, language, etc. This, in turn, is used for training and coaching. However, in any chat program that is operationally well executed, only a fraction of even a bottom quartile chat agent is of really poor quality. So, the random sampling approach would not likely extract out these chats. However, because the agent performance model scores all chats on all these attributes, we can extract out the targeted chats that are the lowest scoring and that are most likely to contain clues on the agents' areas of weakness.

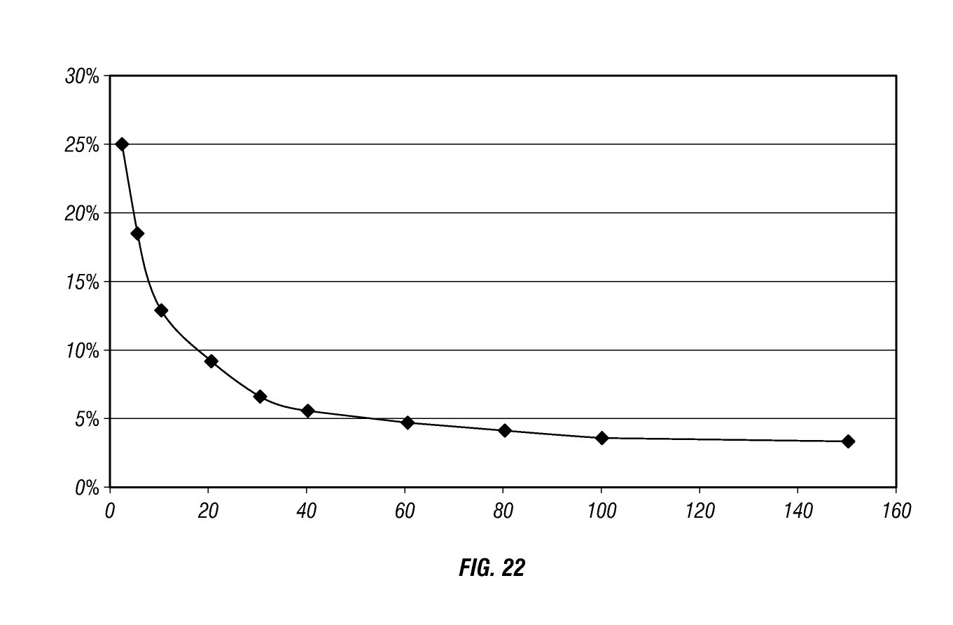

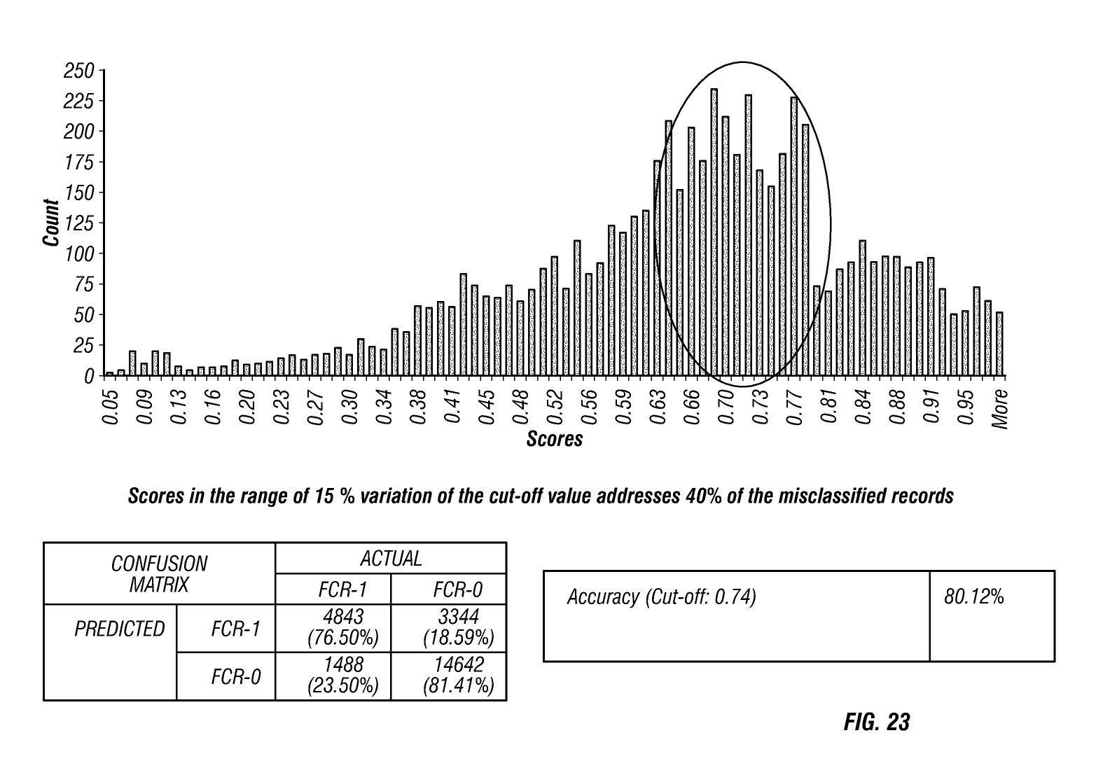

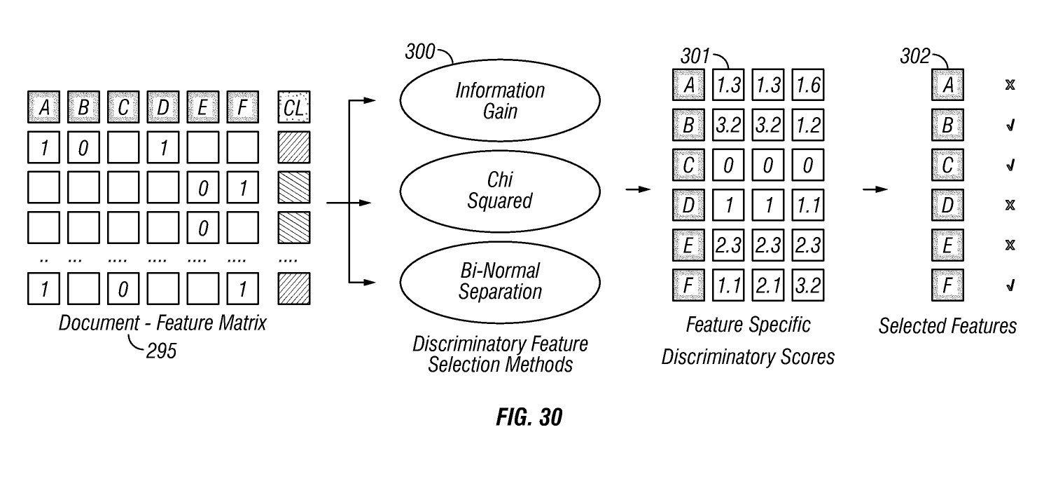

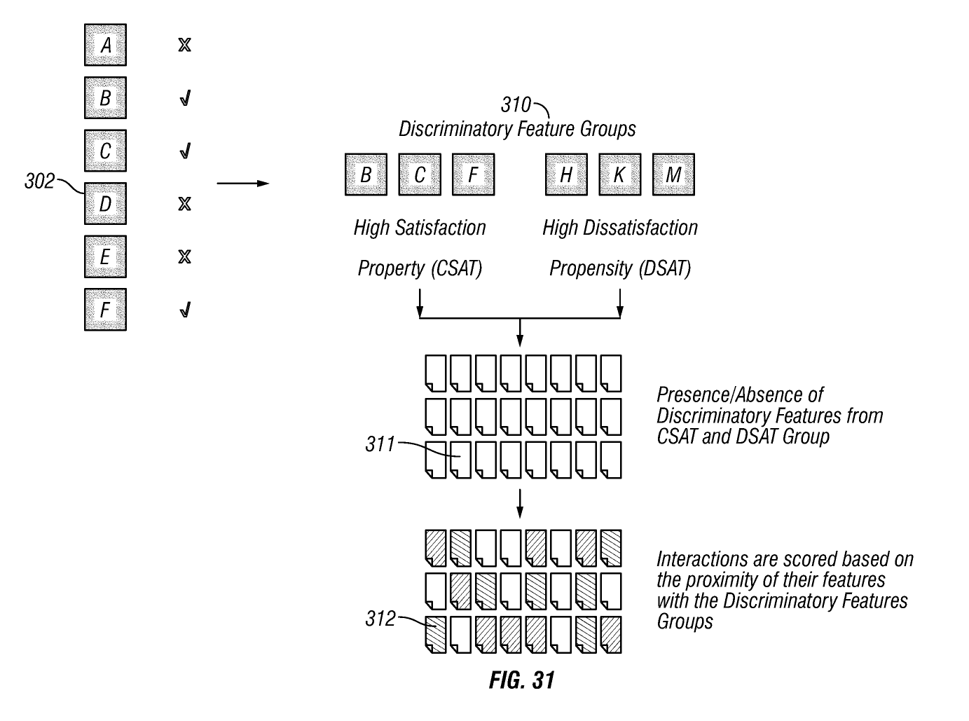

The accuracy of the model is very high compared to a QA process due to the at least following reasons:
The model measures the agent performance not based on a few (1-5) random samples per agent every month, but on 100% of the chats that the agent has taken;
The accuracy of the model calculated score when the score is averaged over 30+ chats per agent is over 95% (see FIGS. 22 and 30). Given that a chat agent takes 30 chats in approximately a day, this means that the model can evaluate the agent very accurately on a daily basis.
The error rate has been found to be highest when the score is near the threshold (see FIGS. 23 and 31) of good and bad. If these interactions are removed from the samples being scored then we are still scoring the agent on 85% of the transactions with even greater accuracy.

The agent performance model can also be used to identify chats that scored best in each of the attributes important to the customer. This, in turn, can be used to build “Best-in-class” knowledge bases. For example, if we identify the chats for a certain issue type, e.g. “how do I set up email in my blackberry?” that have provided the best customer experience, the herein disclosed model can learn features from these chats and provide a “Best Practice” recommendation for that particular query type.

The agent performance model can be used for, for example, on-going measurement of agent performance; recruitment, e.g. testing and automating the measurement of performance of potential recruits; and initial and ongoing training, e.g. at the end of any training module, the tool can be used to measure improvement in performance (post training).

The model is normalized and it reduces the impact of non-controllable external factors. Each text mining driver variable, e.g. softskill, is compared and regressed with customer feedback score on similar factor that comes from the survey, e.g. regress text mining helpfulness score with agent helpfulness score from survey. This process reduces the measurement bias due to the text mining modeling error. Any variation due to external factors, e.g. issue type, is considered in the model. Thus, the scores can be compared within subgroups, e.g. inscope vs. Out of scope chats.

The model architecture provides intelligent filtering to identify chats that are most likely to help improve agent performance. In an embodiment, this is accomplished in the following manner:

If an agent scores poorly in one performance attribute, e.g. resolution, then to provide actionable coaching to that agent, the first step is to identify a small sample of chats that would best help illustrate key areas of improvement. To do this, first all the chats with a resolution score below a certain pre-determined threshold are identified. In this population, the chats which also have a low score in other correlated metrics, such as knowledge score, customer engagement score, etc. are filtered out. This extracted sample has a very high probability (95%+) of being a chat that best showcases areas of improvement.

The model architecture is flexible enough to accommodate feedback and introduce new drivers rapidly. If the accuracy of the model dips for any reason, for example if the nature of chat changes, then new features can be learned to by training the model to more recent data and new drivers of performance can be identified

The model can be used for scoring agents during hiring and training as well. Today, hiring is a manual process where the performance of a prospective hire is manually evaluated for various attributes that one looks for in a prospective chat agent. This process can be completely automated by the agent performance model where the performance of the prospective employee is measures using the model. Similarly, the impact of a training program can be measured by the agent performance model by measuring performance before and after a training program.

Agent Performance

Agent Performance is a major driver of key business metrics such as resolution and customer satisfaction. An agent performance model provides a comprehensive framework for managing agent performance metrics objectively in a data driven way. The exemplary model statistically breaks down the drivers of key business metrics (CSAT and resolution). The model ranks agents using 100% of their transaction records and thus completely removes statistical uncertainties in performance monitoring. It scores agents across multiple dimensions using both structured data and the chat text, and shows the impact of measurable and implementable operational matrices that helps in operational process improvement. It can segregate the impact of non-controllable factors and hence can target better the normalized performance measures. The model is productized and can be implemented quickly with relatively small service layer. The model framework is dynamic and can be customized quickly to cater to any specific needs, e.g. see impact of end customer demographics by integrating CRM data. The model helps in providing recommended usage of text features to agents because it can correlate these with the business matrices. The model also provides a reduction of arbitrariness in QA/Operations monitoring process by targeted chat filtering.

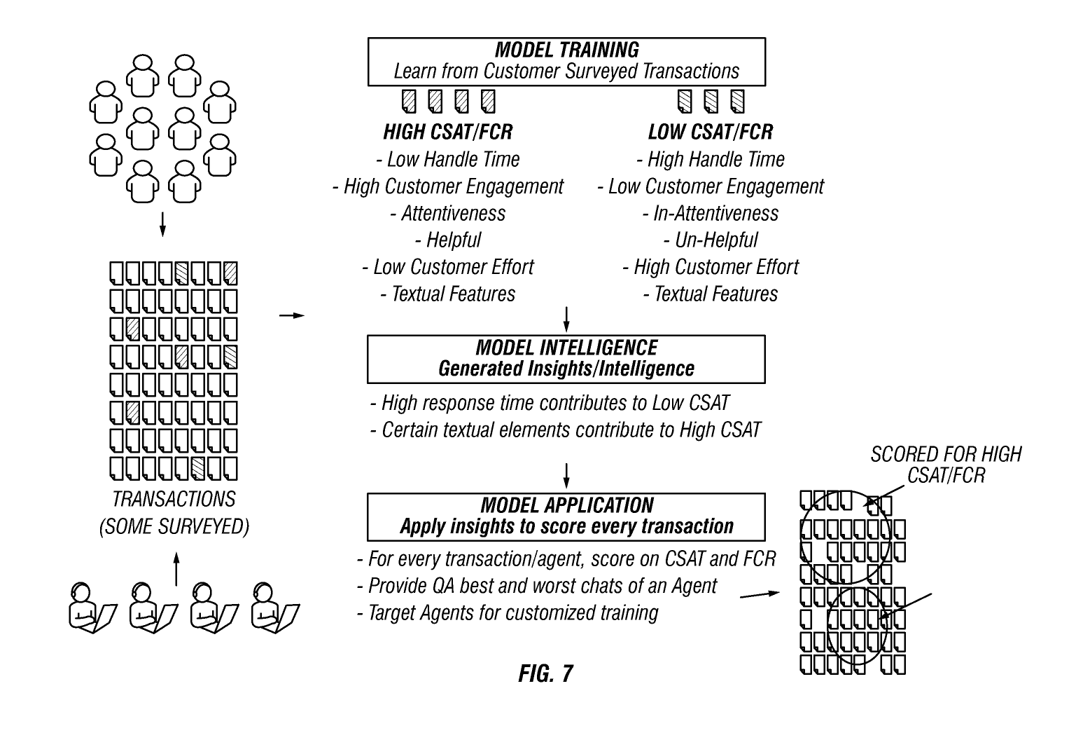

FIG. 7 is a block schematic diagram showing agent performance. In FIG. 7, drivers of business metrics, e.g. CSAT, are selected from structured data and unstructured text. Correlation and importance of these drivers are established based on customer votes from the surveys. All transaction records are scored using the established relationships of the drivers. Feedback provided at any level of drilldown.

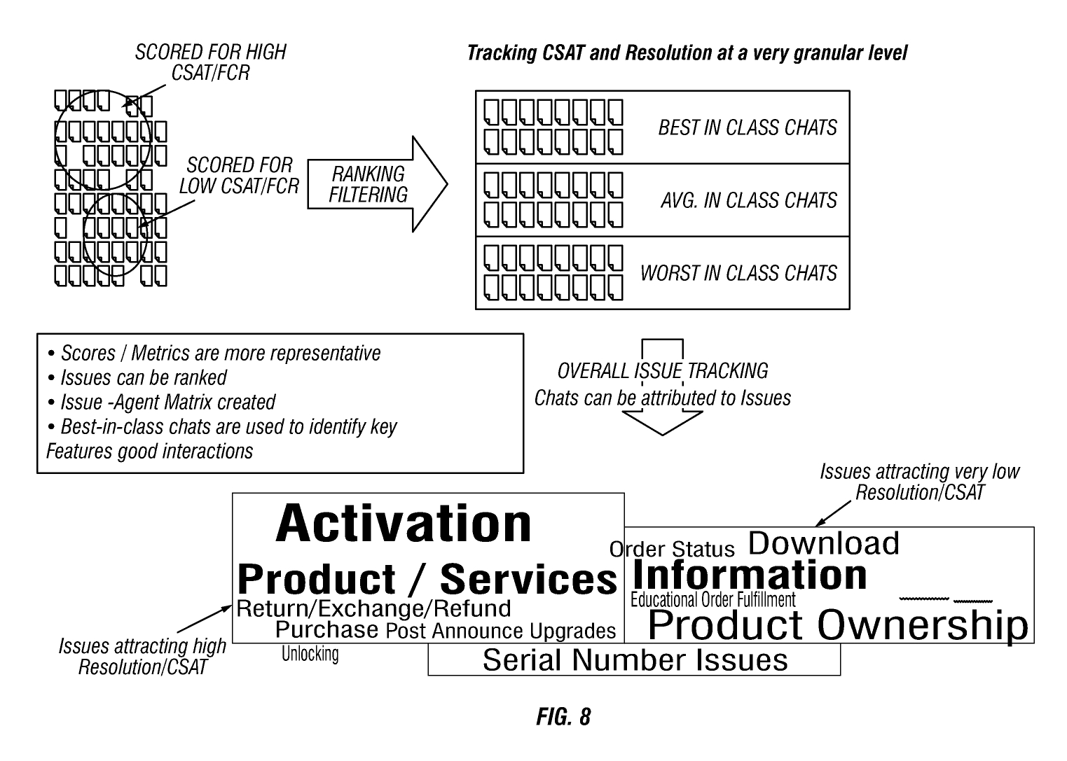

FIG. 8 is a block schematic diagram showing agent performance impact, especially with regard to operations (tracking issue analytics). In FIG. 8, issue type plays a major role while measuring agent performance. No agent should be penalized for any out of scope chat. These performance measures are normalized based on the issue type. The model provides feedback on the relative ranking on issues based on customer experience and helps an operation facility to build strategies to deal with issues.

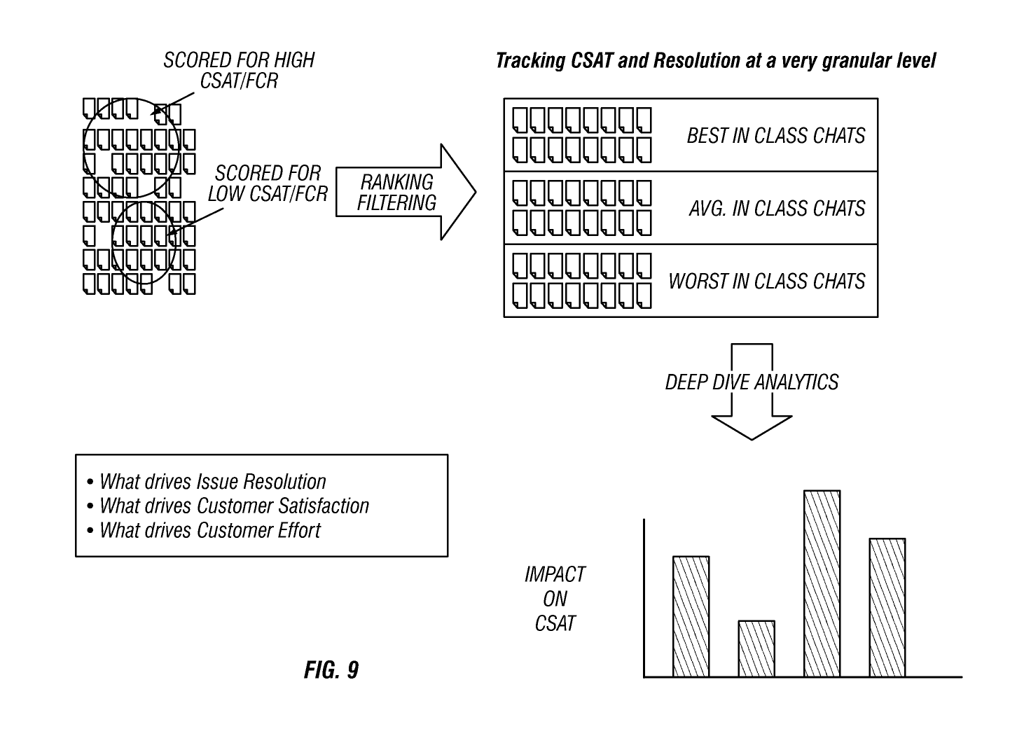

FIG. 9 is a block schematic diagram showing agent performance impact with regard to operations (Aggregate Deep Dive). In FIG. 9, the model provides the measurable impact of each driver on the business matrices to the granular level and thus helps strategize on feedback and actions.

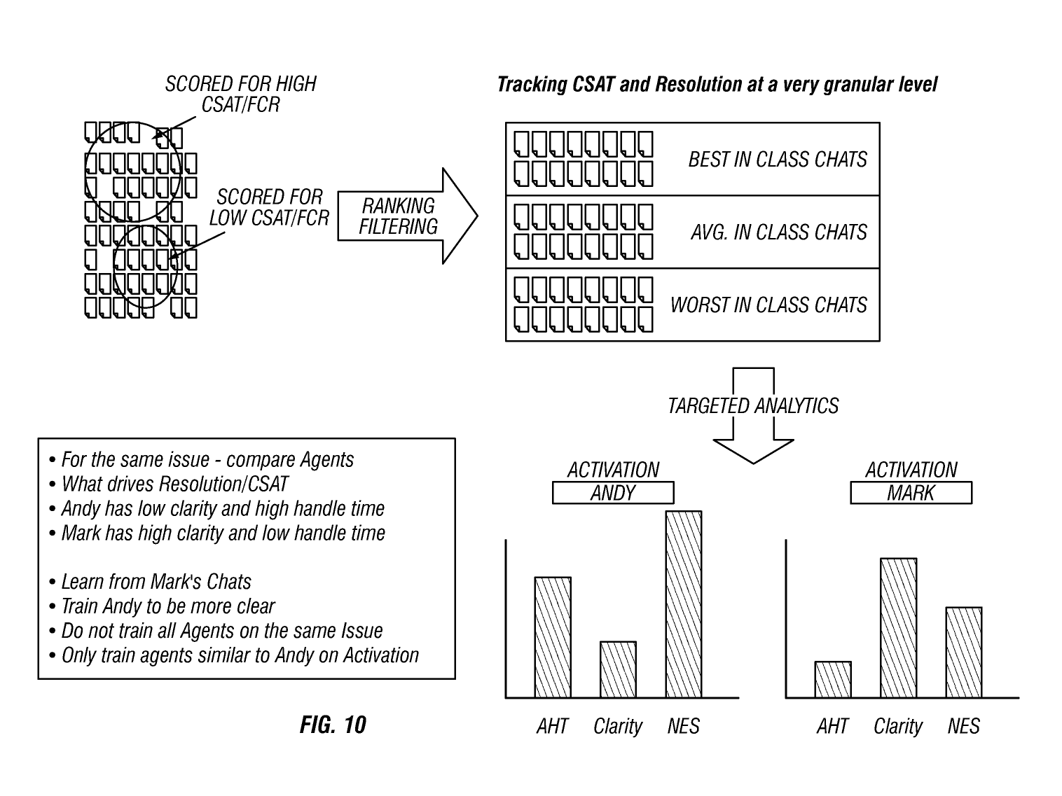

FIG. 10 is a block schematic diagram showing agent performance Impact with regard to operations (Targeted Deep Dive).

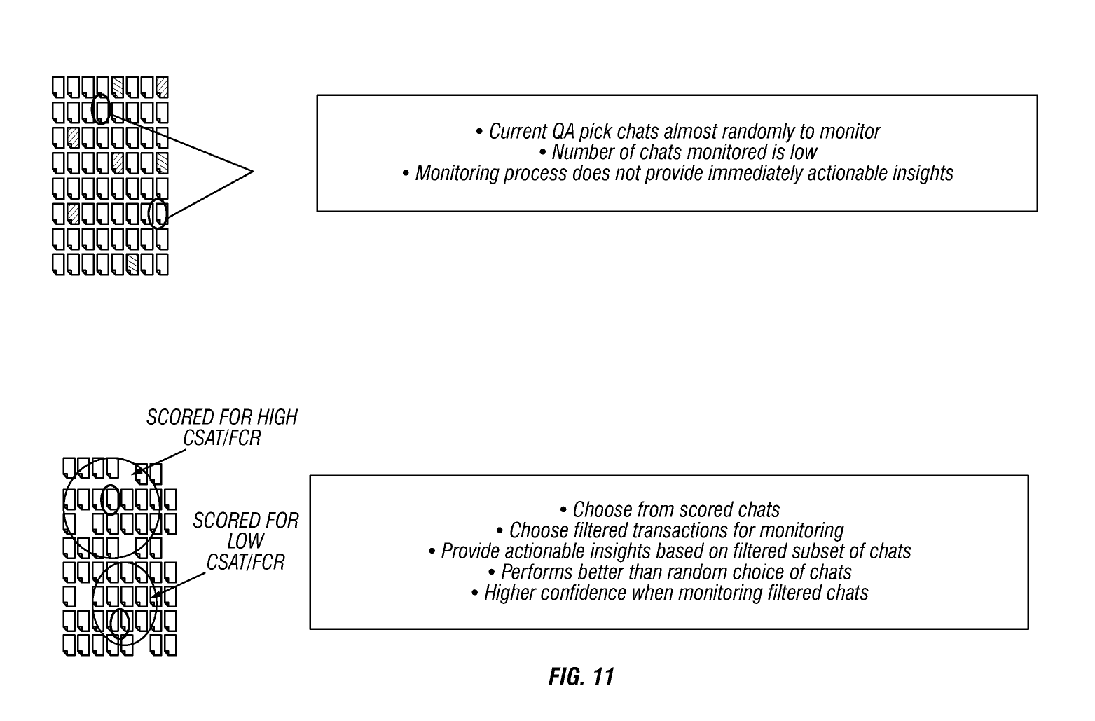

FIG. 11 is a block schematic diagram showing agent performance impact with regard to operation QA (Targeted Monitoring). In FIG. 11, the model helps remove the arbitrariness in performance monitoring.

Agent Performance Modeling

FIG. 12 is a block schematic diagram showing an exemplary text mining architecture. FIG. 12 shows structured Attributes Considered for Resolution Modeling.

Survey Resolution Score—Response

A host of easily measurable and implementable structured variables are used in the model for easy operationalization.
Issue Type
Handle Time
Average Agent Response Time
Standard Deviation Agent Response Time
Average Visitor Response Time
Standard Deviation Visitor Response Time
Agent First Line After
Agent Lines Count
Customer Lines Count
Customer Lines/Agent Lines

FCR and CSAT Drivers

FCR is a function of Resolution and Knowledge from text mining classification based on a resolved and unresolved training set and other structured attributes.

CSAT is a function of:
Empathy score (from text mining)
Customer influencing score (customer NES movement from beginning of chat to end of chat)
Helpfulness (from text mining)
Professionalism (from text mining)
Understanding & Clarity (from text mining)
Attentiveness (from text mining)
Other Structured attributes

FCR and CSAT are used as a proxy of Resolution and Interaction Effectiveness of agents. Model uses the customer vote from the survey. Drivers of these performance attributes are established from a set of structured variable and unstructured chat text.

How is Agent Performance Model Built?

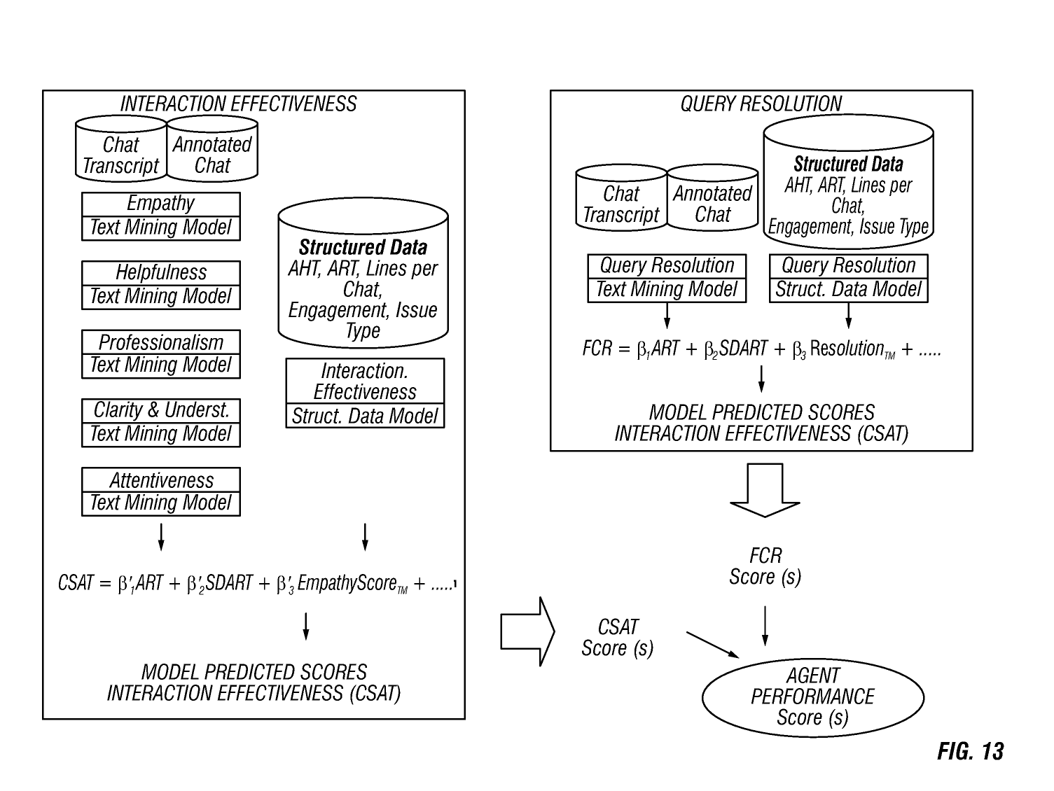

FIG. 13 is a block schematic diagram showing modeling with regard to individual modeling components and types.
Build predictor model for FCR and CSAT using subset interaction records having survey results:
FCR: Estimate ‘beta’ for all attributes used. These ‘beta’s show relative weightage of factors influencing FCR.
CSAT: Estimate ‘beta’ for all attributes used. These ‘beta’s show relative weightage of factors influencing CSAT.
Softskill models are built and trained using QA data.
Accordingly:
CSAT=β₁′ART+β₂′SDART+β₃′EmpathyScore_{TM}+ . . . , where β₁′, β₂′, . . . are coefficients that need to be estimated
Score the entire dataset using these ‘beta’ parameters.

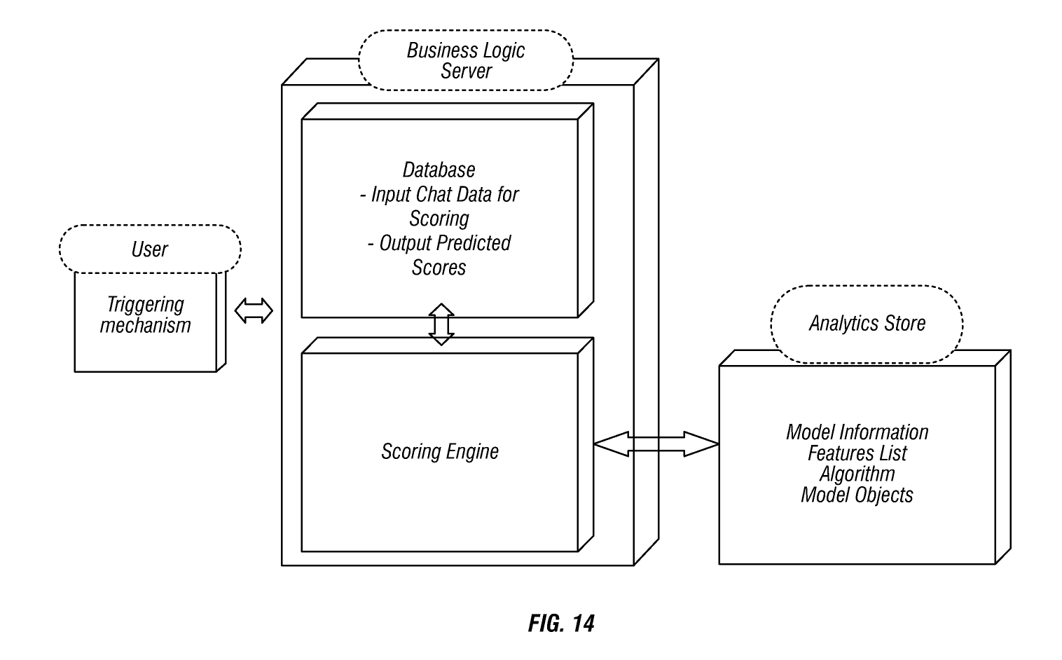

FIG. 14 is a block schematic diagram showing calls analytics solution by triggering.

Resolution Model

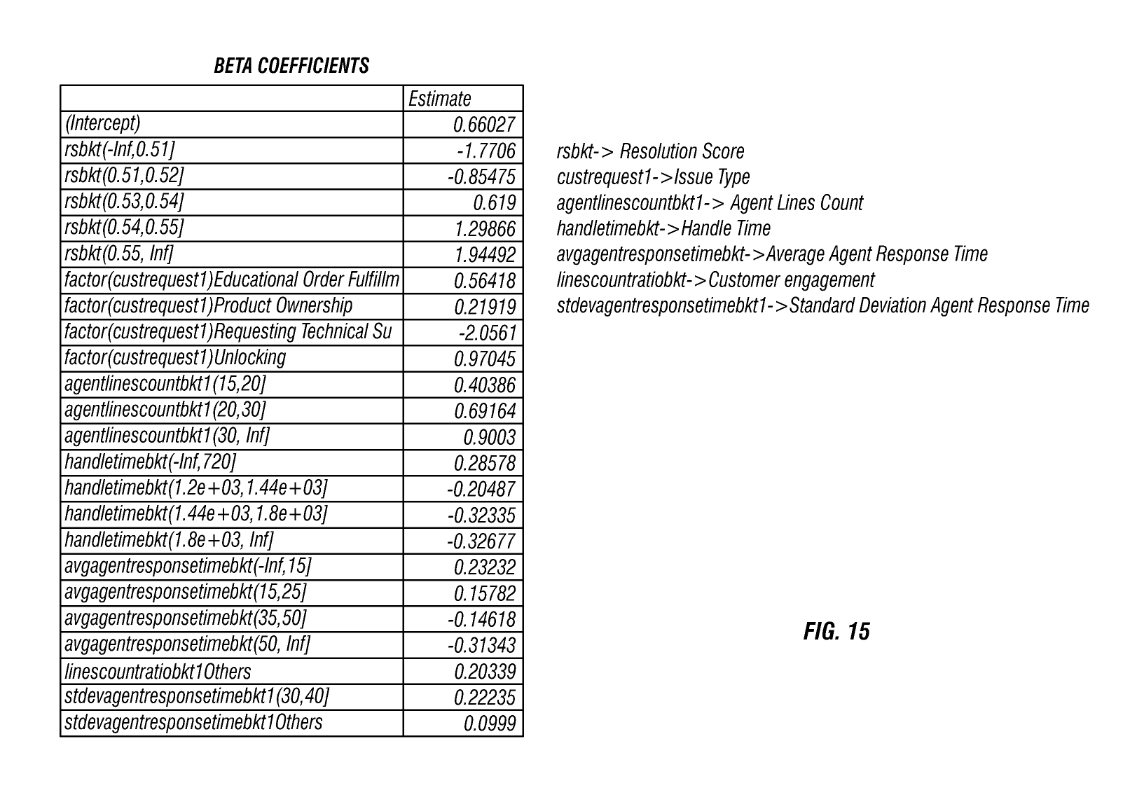

FIG. 15 is a table showing a logistic regression model. The model provides relative impact of key drivers of customer satisfaction or resolution. These could be calculated by several statistical methods, including logistic regression.

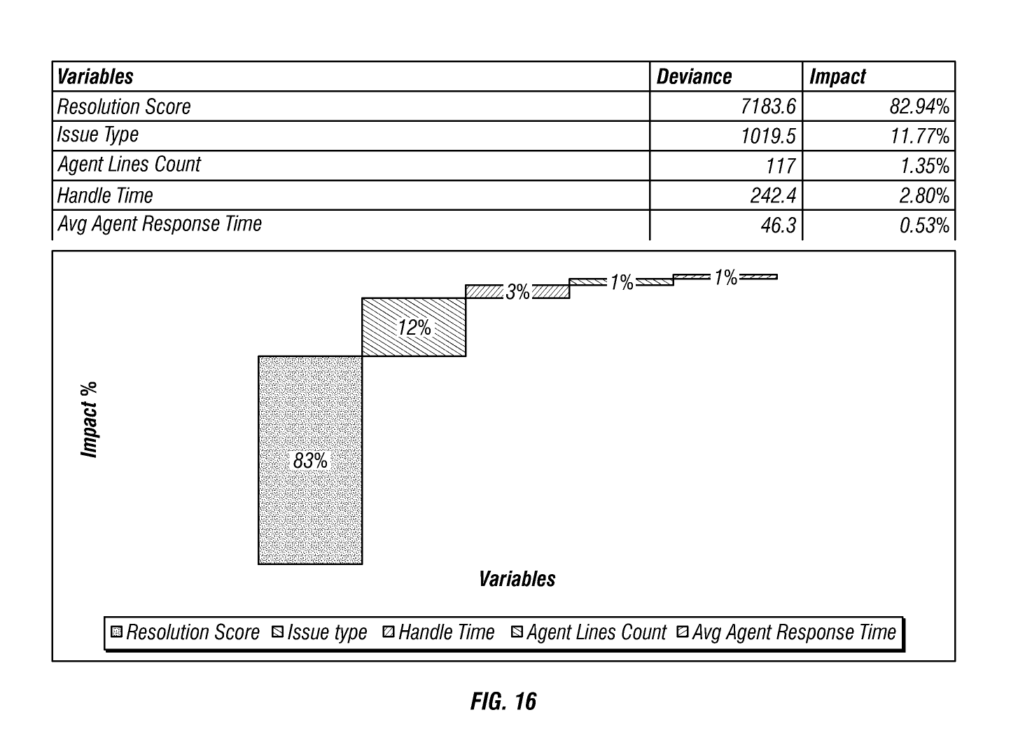

FIG. 16 is a graph that shows a measure of significance and relative explanatory power of various structured/unstructured attributes on a predicted resolution score (FCR). The score from the text mining model for resolution explains a majority of the variance.

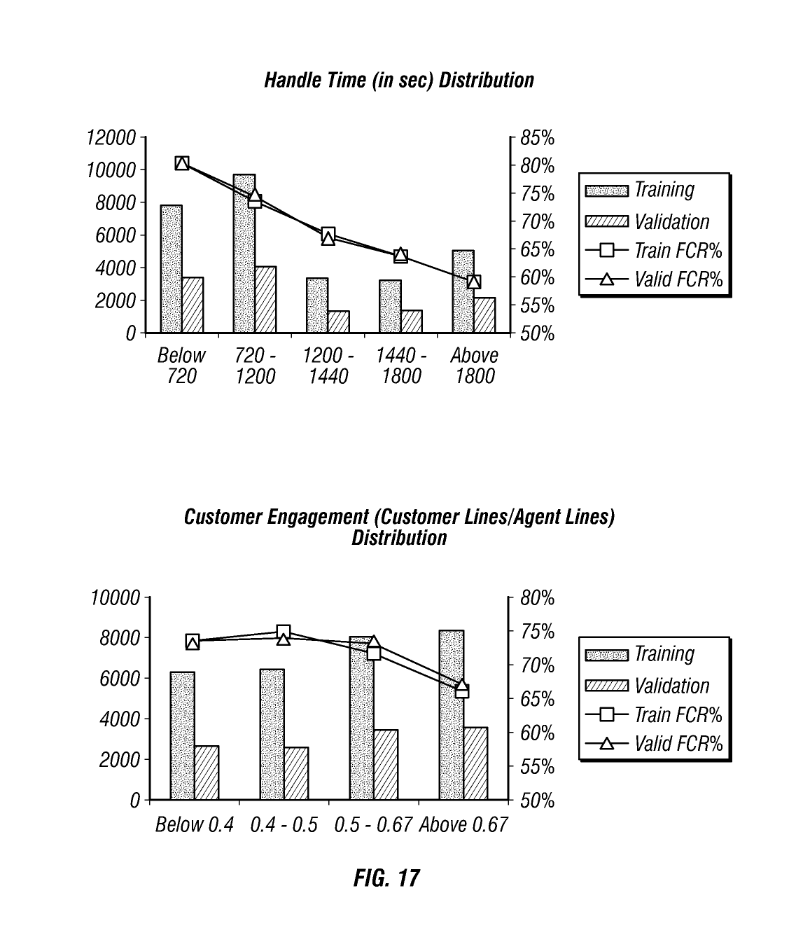

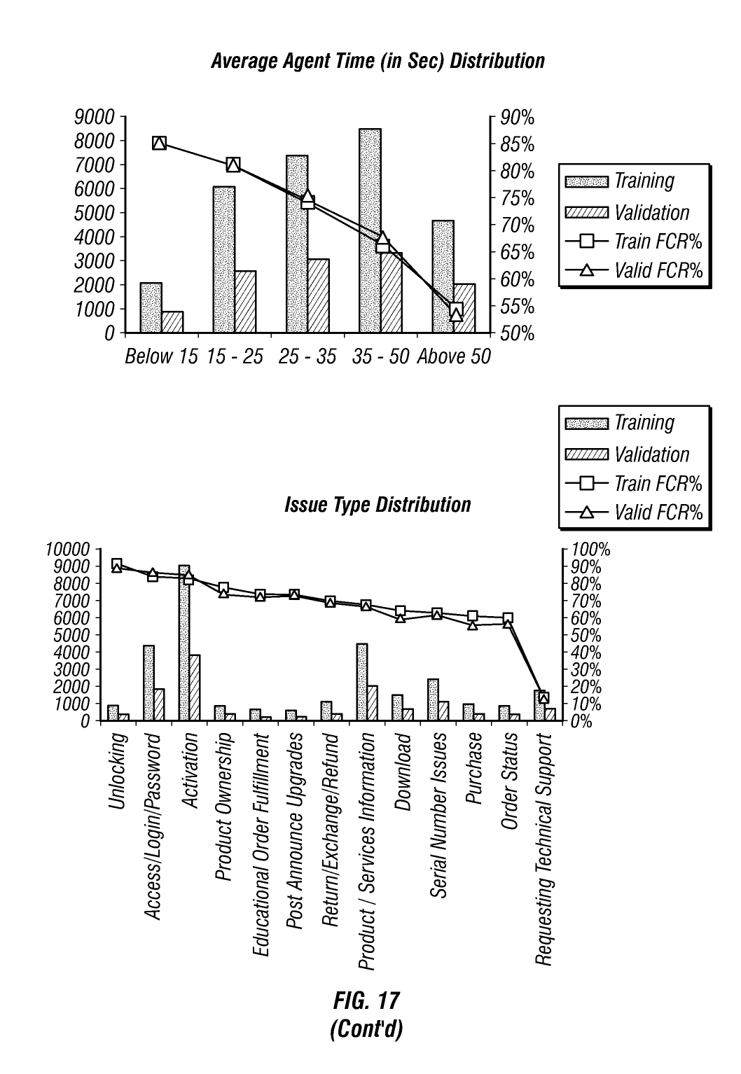

FIG. 17 provides four graphs which show bivariate results for training and validation data. This plot essentially shows that the training and validation data behave similarly, indicating that the model is robust and not overfitted.

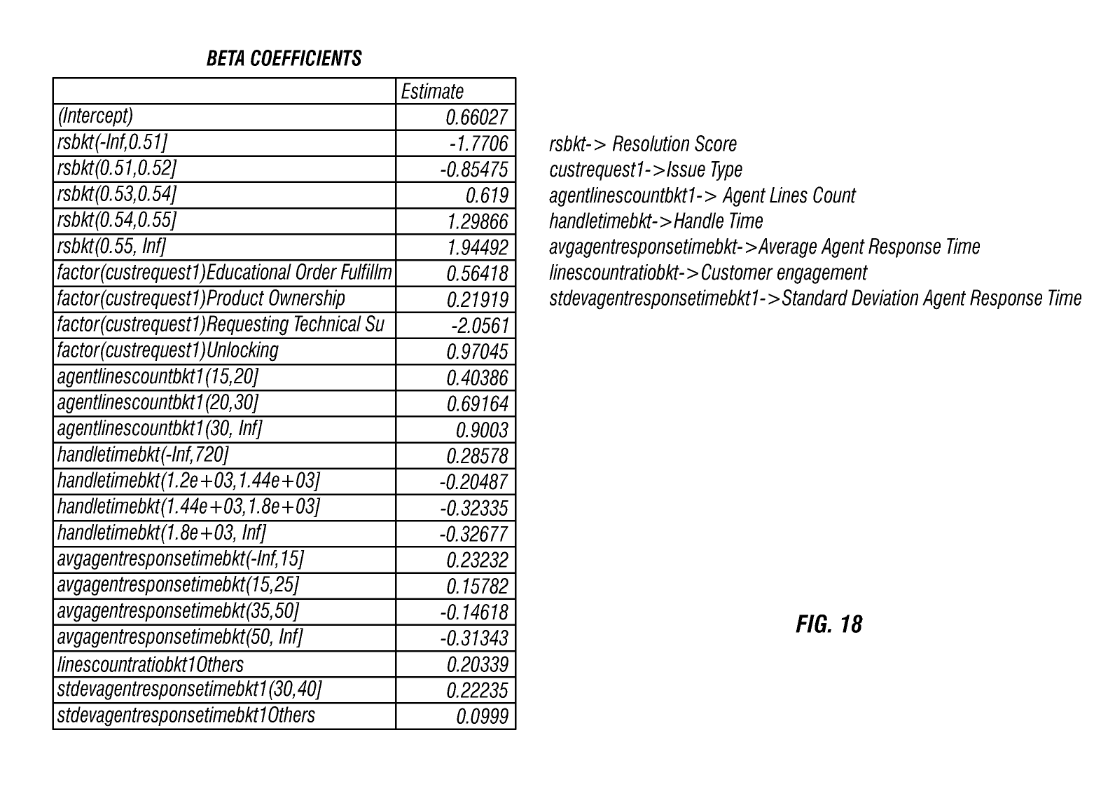

FIG. 18 is a table showing a logistic regression model.

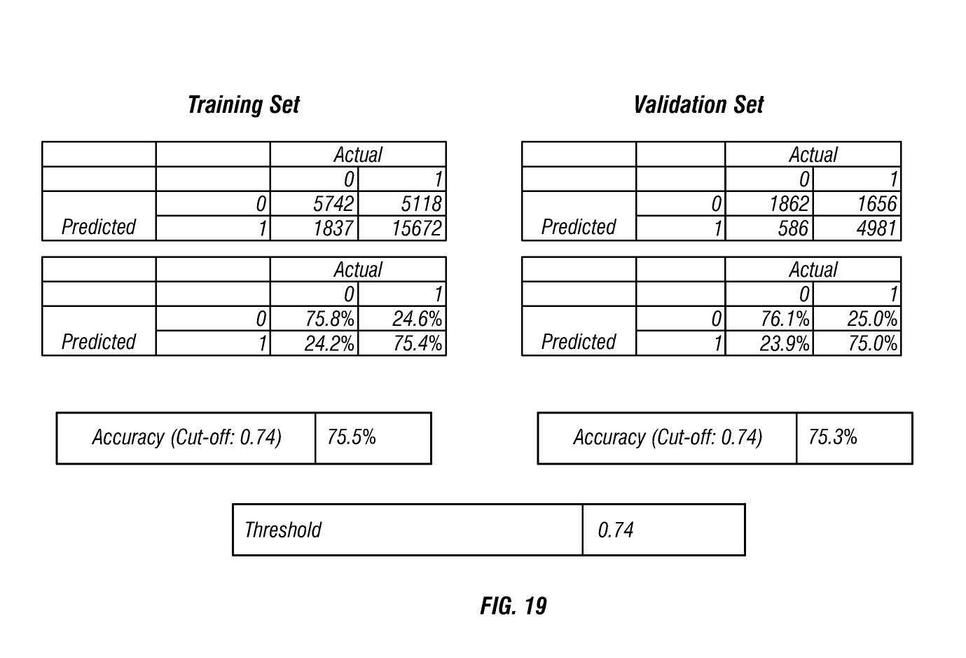

FIG. 19 is a graphic representation of a confusion matrix. Consistency between training and validation sets indicates robustness and the fact that the model is not overfitted. The model predicts correctly approximately 75% of the time.

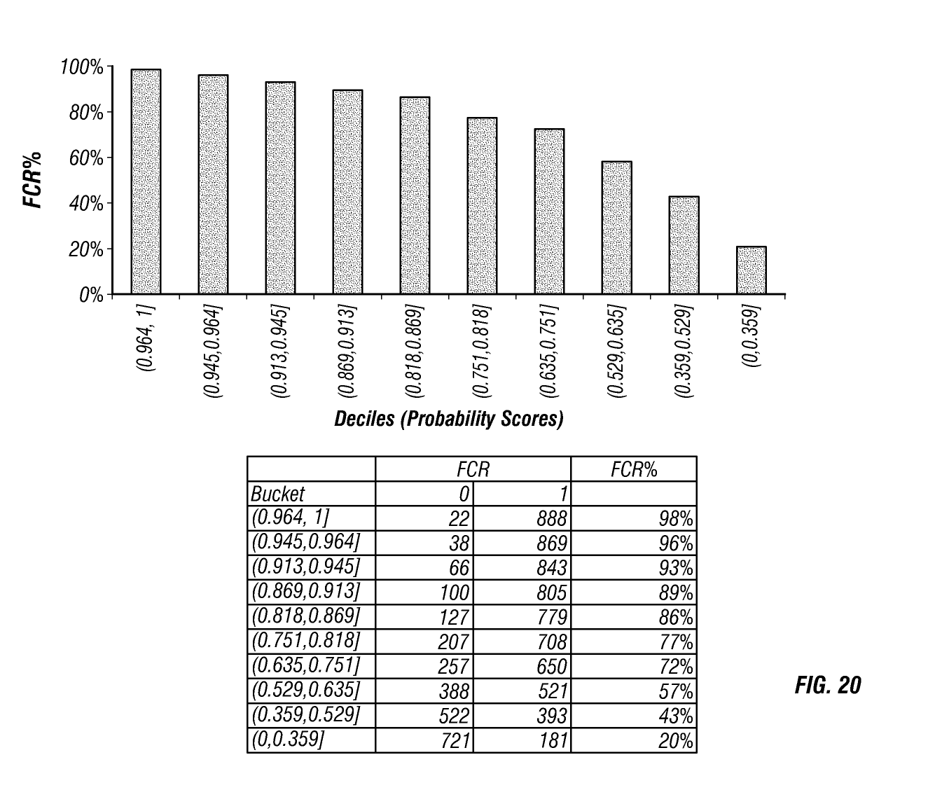

FIG. 20 provides a graph and a table showing an FCR decile chart. The key conclusion here is that for each of the deciles the predicted and actual FCR scores match very well.

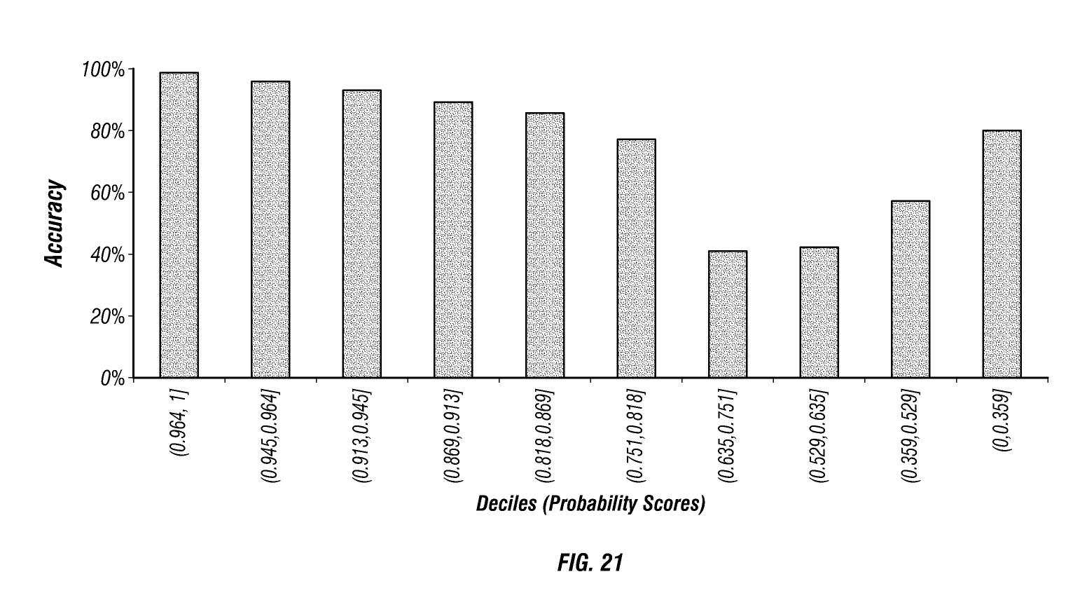

FIG. 21 shows an error chart. As expected, error rates are higher near the threshold.

FIG. 22 is a graph showing an accuracy report for the resolution model. For a single measure, FIG. 19 shows an approximately 75% accuracy. However, agent scores are reported as an average of multiple samples. For 20 to 40 samples the error rate is 5-10% (90 to 95% accurate). Above 50 samples, the error rate is 5% (95%+ accurate). The model shows a high level of accuracy with relatively small sample size that is achievable on a day to day basis.

FIG. 23 is a graph showing misclassified records analysis on a validation set. The key point here is that the misclassification is maximized near the threshold score. This is an important result because if we ignore agent scores near the threshold, then the model is able to measure agent performance even more accurately.

Customer Experience Model

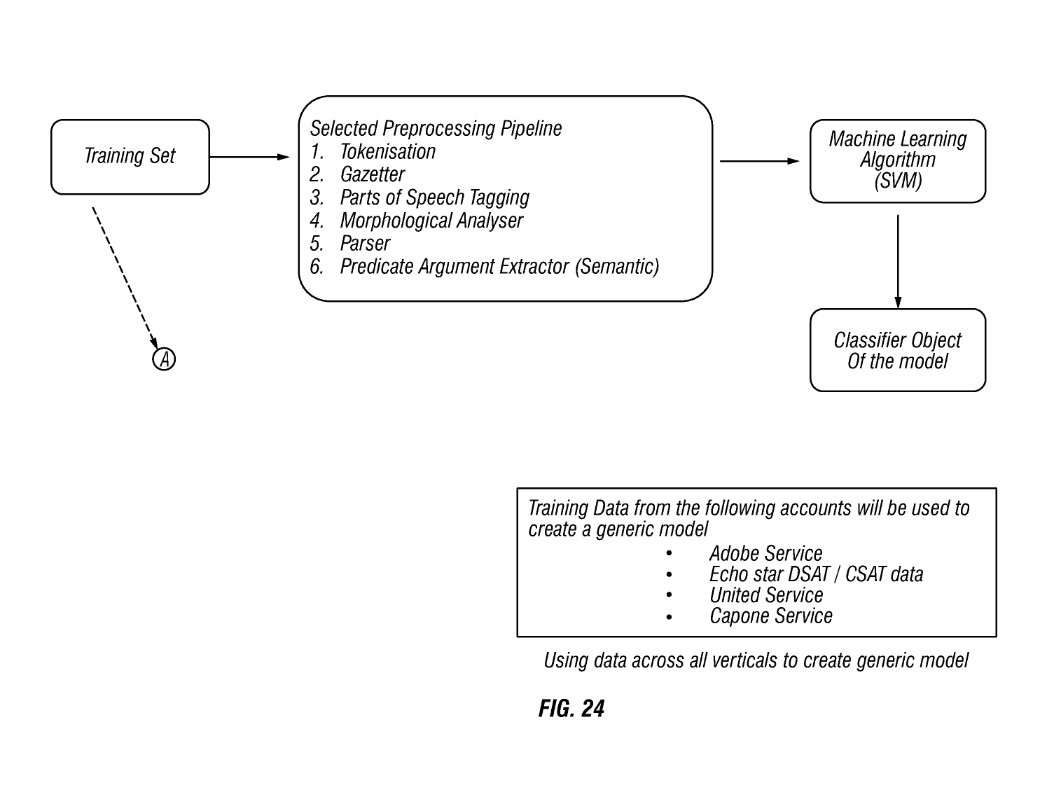

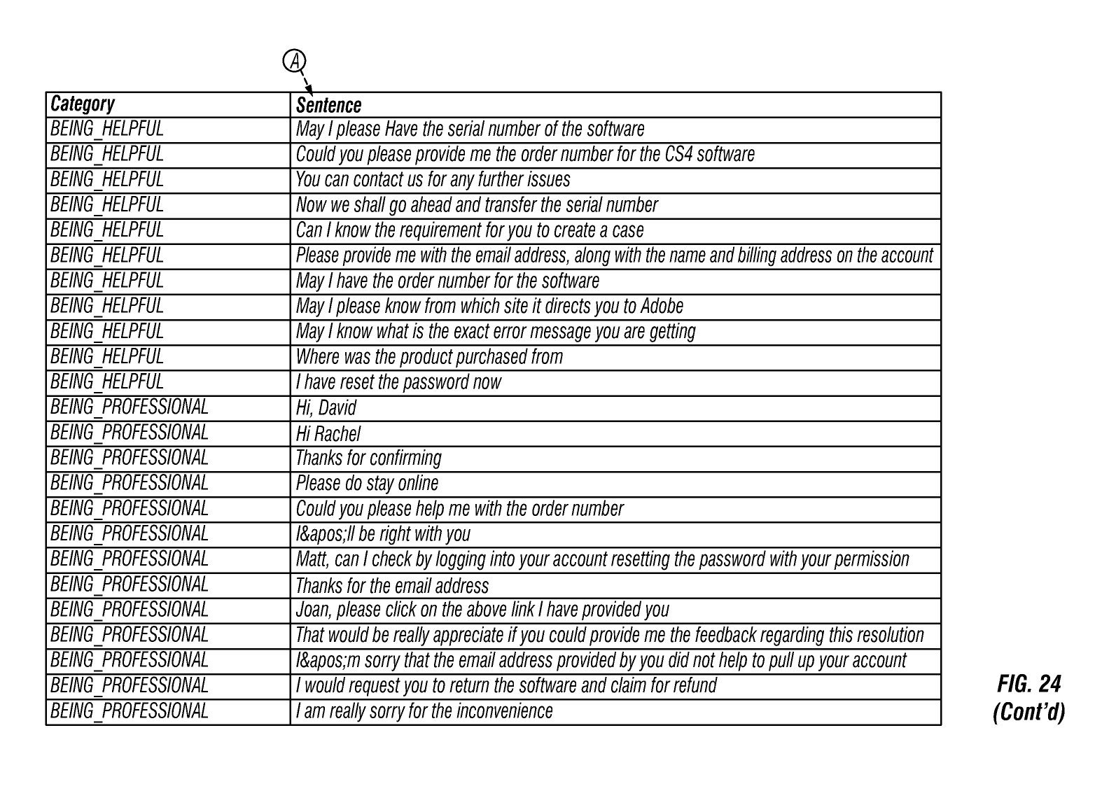

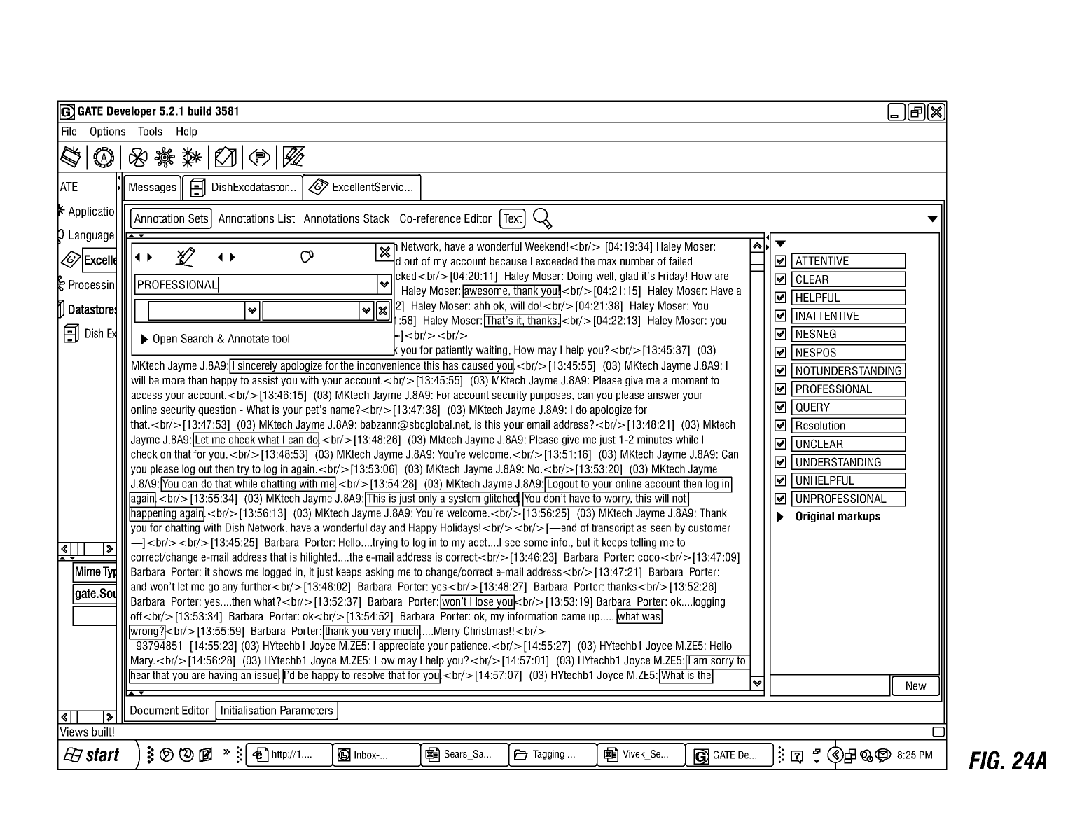

FIG. 24 is a block schematic diagram showing an agent softskill model with regard to a preparation phase. A thorough and robust text mining approach is taken in the preprocessing stage to get rich feature vectors. Generic agent softskill models are created using transaction records across domain and industry verticals. The model can be richer and more contextual if the feedback mechanism is implemented through the herein disclosed QA integration. A collaborative tagging approach can be used to leverage the QA and agent resources to improve the model efficacy. FIG. 24a is an example screenshot showing interaction annotation via GATE software according to the invention.

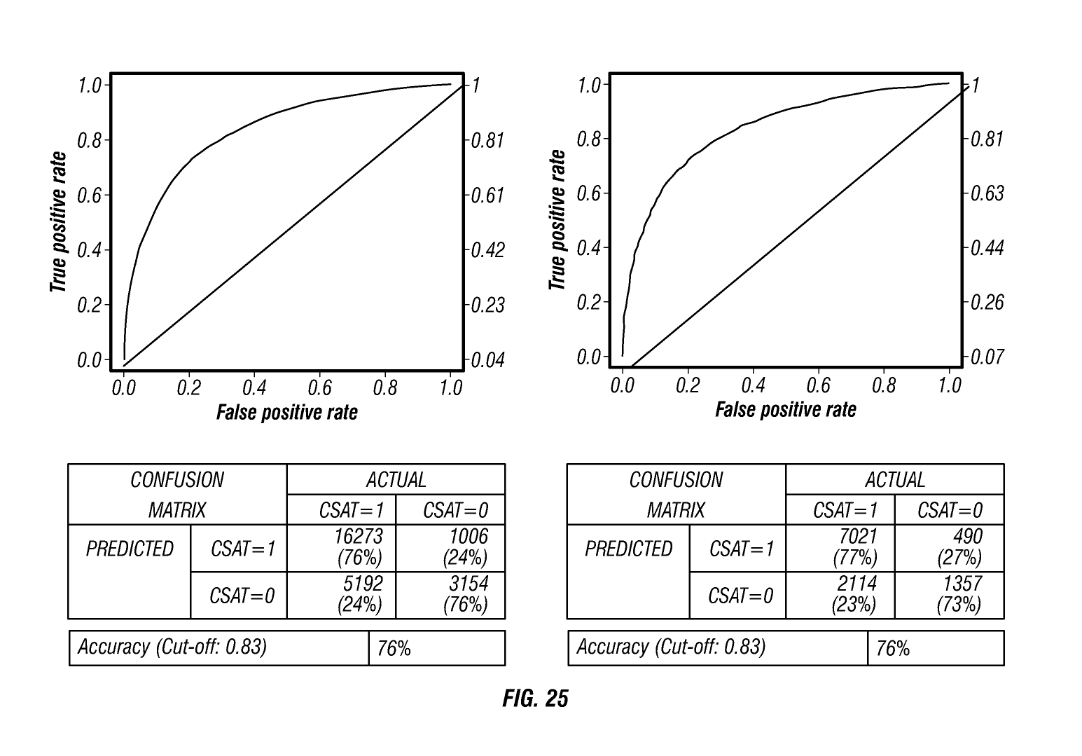

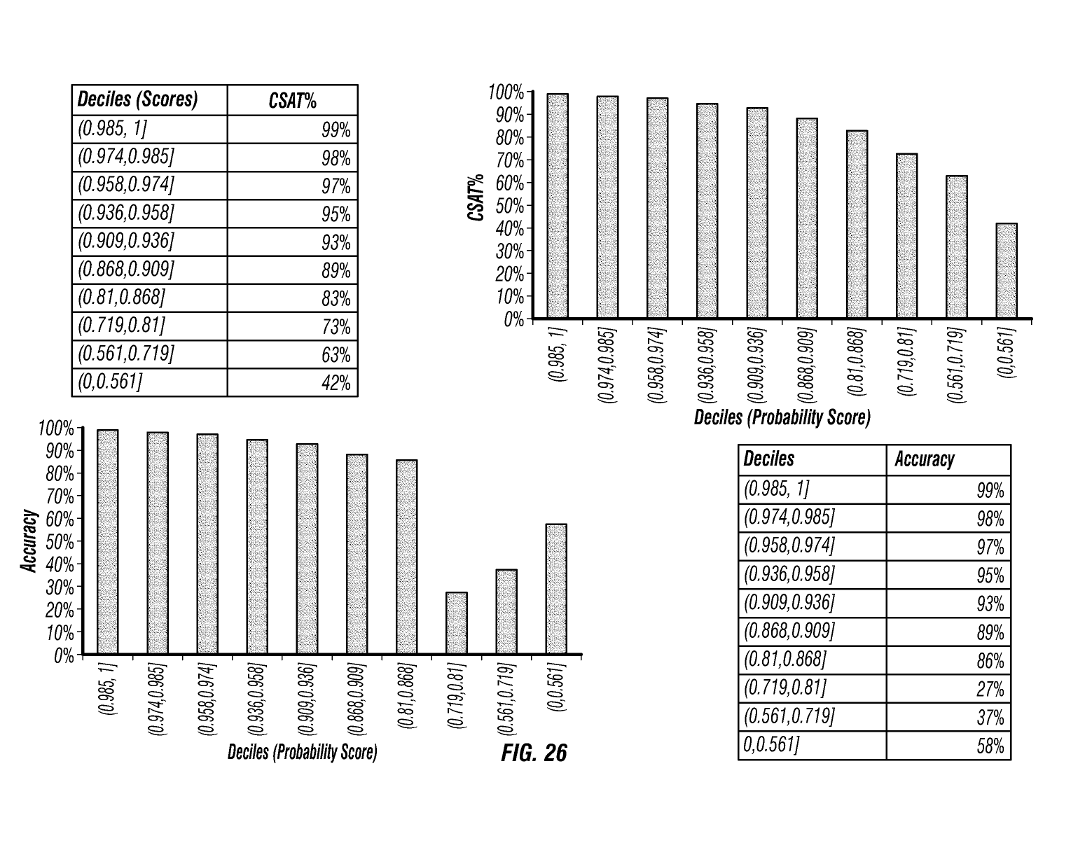

FIG. 25 is a pair of graphs that show performance of structured and unstructured data model for CSAT. FIG. 25 is similar to FIG. 19 except that FIG. 19 illustrates FCR and FIG. 25 illustrates CSAT.

FIG. 26 is a set of graphs and tables that show performance measured on deciles of calculated scores.

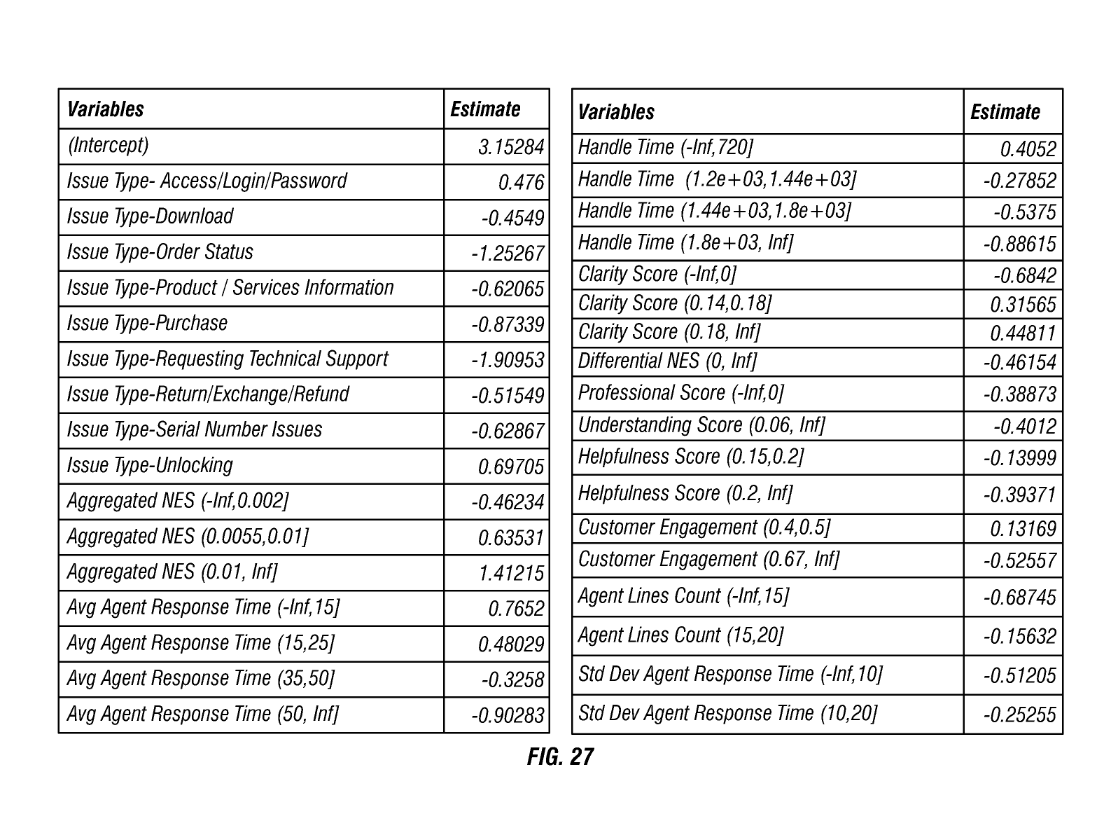

FIG. 27 is a table that shows estimated coefficients.

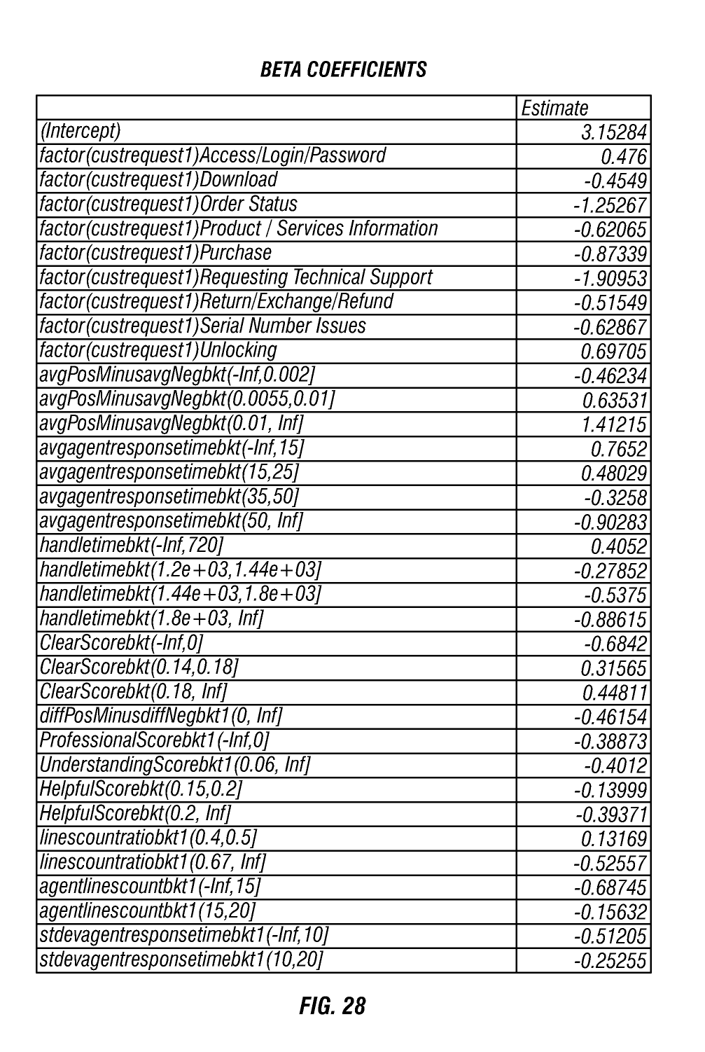

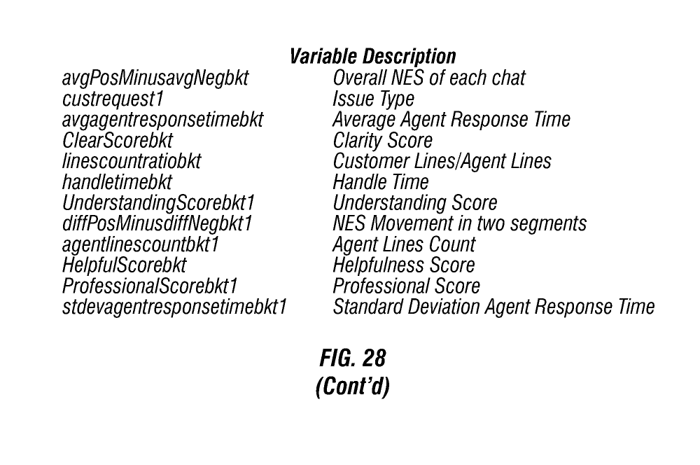

FIG. 28 is a table that shows a logistic regression model.

Using Discriminatory Features to Identify Customer Satisfaction in Chat Interactions

In the Customer Lifecycle Management industry, a Customer Service Representative (CSR) interacts with customers by engaging them in any or all of voice, chat, and email communication. With regard to online chat communications, an embodiment of the invention leverages quantitative and predictive methods to separate chat interactions that have a positive or negative influence on the customer.

A further embodiment of the invention provides methodologies by which Quality Control personnel can isolate problem areas of a chat interaction. This embodiment identifies markers that signal a negative customer experience. This provides a mechanism for creating a prediction model and allows for offline training and coaching enhancements for CSR personnel to perform better in future customer engagements.

Selection of Discriminating Features from Chat Interactions

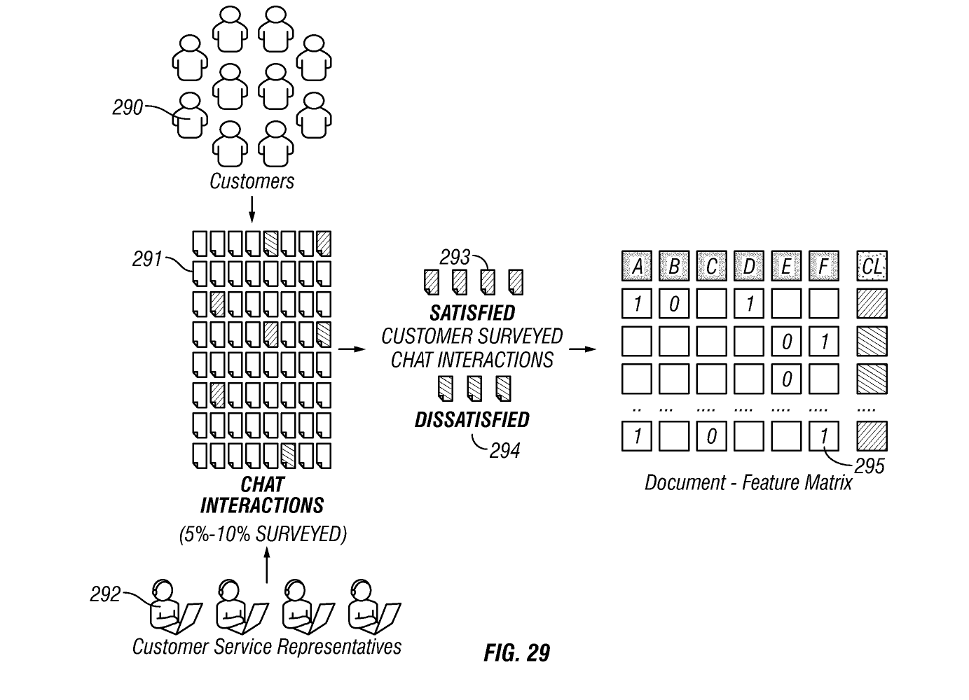

See FIG. 29. Chat interactions are text based. A CSR 292 and a customer 290 engage in an exchange of sentences 291, each with a specific purpose and function. The customer intends to resolve an issue or receive an answer to a query from the customer service personnel. On occasion, the customer disengages from the interaction with a negative resolution and a subsequent dissatisfied experience. This embodiment employs text mining techniques to try to isolate textual features that may cause a dissatisfactory experience for the customer. This is done by using responses to surveys that customers are requested to answer at the end of an interaction. The survey responses can either be positive 293 or negative 294, which allows for the isolation of the satisfactory and dissatisfactory chat interactions.

After grouping the chat interactions into two groups based on the customer response 295, a feature extraction process is executed on the interaction transcript (see FIG. 30). The textual features are isolated in the form of individual words, phrases and n-grams. Natural language processing techniques, such as shallow parsing and chunking, are used to isolate phrases that have specific grammatical structures 300, such as noun-noun phrases, noun-verb phrases, and such other grammatical constructs

Features are scored for their discriminatory importance 301. Features which have a higher propensity of belonging to the dissatisfactory interactions are given a negative score and those that exhibit a higher propensity of belonging to the satisfactory interactions are given a positive score. The method of feature selection is based on a multitude of statistical techniques, such as Information Gain, Bi-Normal Separation, and Chi-Squared.

Each method attributes a score to each feature. The discrimination scores are then aggregated to provide a composite score based on which the final group of features are determined. Features are retained based on a threshold that controls for the discriminatory importance and the quantity of features retained 302.

Identifying Satisfaction and Dissatisfaction Propensity in Chat Interactions by Using Discriminatory Features

FIG. 31 is a flow diagram that shows identification of satisfaction and dissatisfaction propensity in chat interactions by use of discriminatory features. Discriminatory features, once selected, are grouped into two categories 310. Those features that have a higher propensity to belong to dissatisfactory interactions are called DSAT features, and those that contribute to a satisfactory interaction are called CSAT features.

New interactions are scored for their propensity to belong to either the CSAT or DSAT group. An interaction is scored by quantifying the intersection of features in that interaction with the CSAT and DSAT features group 311. If the similarity of features is high with the CSAT group, the interaction is labeled Satisfactory and an associated confidence score is attributed to it. If the similarity of features is high with the DSAT group, the interaction is labeled Dissatisfactory and an associated confidence score is attributed to it.

Similarity scores of interaction features with the two discriminatory feature groups (CSAT and DSAT) are determined by employing such statistical distance methods as Euclidean, Jaccardian, and Cosine, amongst others. A high similarity measure with a certain discriminatory feature group qualifies that interaction to belong with a high probability to that group 312. Because an interaction is an exchange of sentences between a customer and a CSR, it is also possible to isolate the sentence in which a word-feature occurs. This allows the Quality Control personnel to identify precisely the reason for a dissatisfactory experience and recommend changes to the CSR to avoid future incidents of a negative customer experience.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. Apparatus for using discriminatory features to identify customer satisfaction in chat interactions, comprising:
a processor configured for receiving inputs form an online chat communications facility with which a customer service representative (CSR) interacts with customers; and
said processor configured to leverage quantitative and predictive methods to separate chat interactions that have a positive or negative influence on the customer by using responses to surveys that customers are requested to answer at the end of an interaction.

2. The apparatus of claim 1, said processor configured to allow quality control personnel to isolate problem areas of a chat interaction by identifying markers that signal a negative customer experience.

3. The apparatus of claim 1, said processor configured for creating a prediction model and allowing for offline training and coaching enhancements for CSR personnel to perform better in future customer engagements.

4. The apparatus of claim 1, said processor further configured for:
grouping chat interactions into at least two groups based on customer response;
executing a feature extraction process on an interaction transcript;
isolating textual features in said interaction transcript;
scoring features for their discriminatory importance, wherein features which have a higher propensity of belonging to dissatisfactory interactions are given a negative score and features that exhibit a higher propensity of belonging to satisfactory interactions are given a positive score;
attributing a discrimination score to each feature; and
aggregating discrimination scores to provide a composite score upon which a final group of features are determined, wherein features are retained based on a threshold that controls for discriminatory importance and a quantity of features retained.

5. Apparatus for identifying satisfaction and dissatisfaction propensity in chat interactions by using discriminatory features, comprising:
a processor configured for selecting discriminatory features;
said processor further configured for grouping said discriminatory features into at least two categories, wherein features that have a higher propensity to belong to dissatisfactory interactions comprise DSAT features and features that contribute to a satisfactory interaction comprise CSAT features;
said processor further configured for scoring new interactions for their propensity to belong to either the CSAT or the DSAT group, wherein an interaction is scored by quantifying an intersection of features in that interaction with the CSAT and DSAT group;
wherein if a similarity of features is high with the CSAT group, the interaction is labeled Satisfactory and an associated confidence score is attributed to it;
wherein if a similarity of features is high with the DSAT group, the interaction is labeled Dissatisfactory and an associated confidence score is attributed to it.

6. The apparatus of claim 5, wherein similarity scores of interaction features with the two discriminatory feature groups (CSAT and DSAT) are determined by employing statistical distance methods.

7. The apparatus of claim 5, wherein a high similarity measure with a certain discriminatory feature group qualifies that interaction to belong with a high probability to that group.

8. The apparatus of claim 15, wherein an interaction is an exchange of sentences between a customer and a CSR; and
wherein said processor is further configured to isolate a sentence in which a word-feature occurs; and wherein said processor further configured to identify precisely a reason for a dissatisfactory experience and recommend changes to a CSR to avoid future incidents of a negative customer experience.
